(19) United States
(12) Patent Application Publication
(10) Pub. No.: US 2014/0071334 A1
(43) Pub. Date: Mar. 13, 2014

(54) IMAGING LENS AND IMAGING DEVICE

(71) Applicant: SANYO ELECTRIC CO., LTD., Osaka (JP)

(72) Inventor: Yohei NAKAGAWA, Moriguchi-shi (JP)

(73) Assignee: SANYO ELECTRIC CO., LTD., Osaka (JP)

(21) Appl. No.: 14/017,194

(22) Filed: Sep. 3, 2013

(30) Foreign Application Priority Data
Sep. 7, 2012 (JP) 2012-197961
Sep. 7, 2012 (JP) 2012-197962
Sep. 7, 2012 (JP) 2012-197963

(51) Int. Cl. G02B 13/00

(52) U.S. Cl. CPC G02B 13/0045
USPC 348/360; 359/764; 359/738

(57) ABSTRACT

An imaging lens is constituted of, in order from an object side to an image side, a first lens element having a positive refractive power and having a convex surface toward the object side; a second lens element of a meniscus shape having a negative refractive power and having a concave surface toward an image side; a third lens element having a positive refractive power and having a convex surface toward the image side; a fourth lens element of a meniscus shape having a negative refractive power and having a convex surface toward the image side; and a fifth lens element of a meniscus shape and having a concave surface toward the image side.

This application claims priority under 35 U.S.C. Section 119 of Japanese Patent Applications No. 2012-197961 filed on Sep. 7, 2012, entitled “IMAGING LENS AND IMAGING DEVICE”, No. 2012-197962 filed on Sep. 7, 2012, entitled “IMAGING LENS AND IMAGING DEVICE”, and No. 2012-197963 filed on Sep. 7, 2012, entitled “IMAGING LENS AND IMAGING DEVICE”. The disclosures of the above applications are incorporated herein by reference.

### BACKGROUND OF THE INVENTION

1. Field of the Invention

The present invention relates to an imaging lens and an imaging device provided with the imaging lens, for instance, a configuration suitable for an imaging lens and an imaging device for a camera to be loaded in a mobile phone or a like device.

2. Disclosure of Related Art

In recent years, an imaging device incorporated with a solid state imaging sensor element such as a CCD image sensor or a CMOS image sensor is used in a camera to be loaded in a personal digital assistant such as a mobile phone or a smartphone. Further, as a high-pixel solid state imaging sensor element has been developed, a higher optical performance has been required for an imaging lens to be loaded in an imaging device. For instance, it is possible to enhance the image quality of a captured image by loading a fast imaging lens with a small F-number. In this case, constituting an imaging lens of five lens elements makes it easy to implement a fast imaging lens with a small F-number, rather than constituting an imaging lens of three or four lens elements.

Japanese Patent No. 4,947,237 discloses a configuration of an imaging lens constituted of five lens elements for reducing the F-number. In this configuration, there are provided, in the order from the object side, a lens element having a positive refractive power and having a convex surface toward the object side, a lens element having a negative refractive power and having a concave surface toward the image side, a lens element having at least one surface formed into an aspherical shape, a lens element having a positive refractive power and having a convex surface toward the image side, and a lens element having a negative refractive power and having a concave surface toward the object side and the image side. According to this configuration, it is possible to implement a fast imaging lens with an F-number of about 2.

In the above configuration, however, the imaging lens is constituted of five lens elements. Accordingly, the entire length of the imaging lens in the optical axis direction tends to increase. On the other hand, in the case where an imaging device is used in a camera to be loaded in a personal digital assistant such as a mobile phone or a smartphone, the installation space of the imaging device is restricted. In view of the above, it is desirable to shorten the entire length of the imaging lens as much as possible.

Further, in a fast imaging lens with a small F-number, there is a drawback that a captured image may be deteriorated due to optical axis misalignment of the lens. If optical axis misalignment occurs in each of the lens elements due to tolerances (manufacturing tolerances) at the time of manufacturing imaging lenses, imaging characteristics (MTF: Modulation Transfer Function) may be deteriorated. With use of the imaging lens disclosed in Japanese Patent No. 4,947,237, it is possible to implement a fast lens with a small F-number. However, the allowable range of optical axis misalignment for obtaining an intended MTF is narrow, and the requirements on manufacturing tolerances are high.

### SUMMARY OF THE INVENTION

A first aspect of the invention relates to an imaging lens for forming an image of a subject on a light receiving surface of an imaging sensor element. The imaging lens according to the first aspect is constituted of, in order from an object side to an image side, a first lens element having a positive refractive power and having a convex surface toward the object side; a second lens element of a meniscus shape having a negative refractive power and having a concave surface toward the image side; a third lens element having a positive refractive power and having a convex surface toward the image side; a fourth lens element of a meniscus shape having a negative refractive power and having a convex surface toward the image side; and a fifth lens element of a meniscus shape and having a concave surface toward the image side.

A second aspect of the invention relates to an imaging device. The imaging device according to the second aspect includes the imaging lens according to the first aspect, and an imaging sensor element which receives light collected on the imaging lens.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams showing an example of a configuration of an imaging lens according to an embodiment;

FIGS. 2A and 2B are diagrams respectively describing characteristics of a third lens element according to the embodiment;

FIGS. 3A to 3D are diagrams respectively showing an arranged position of an aperture stop according to the embodiment;

FIGS. 4A and 4B are diagrams describing a relationship between an arranged position of an aperture stop and an edge thickness according to the embodiment;

FIG. 5 is a diagram showing parameter values in design examples and in comparative example;

FIGS. 6A to 6D are diagrams respectively describing a method for defining predetermined parameter values in design examples and in comparative example;

FIG. 7 is a diagram showing design values of optical elements in comparative example and in design examples 1 and 2;

FIG. 8 is a diagram showing design values of optical elements in design examples 3, 4, and 5;

FIG. 9 is a diagram showing design values of optical elements in design examples 6, 7, and 8;

FIG. 10 is a diagram showing design values of optical elements in design examples 9 and 10;

FIGS. 11A and 11B are diagrams showing optical characteristics (MTF and lateral aberration) of comparative example;

FIGS. 12A and 12B are diagrams showing optical characteristics (field curvature, distortion, and longitudinal aberration) of comparative example;

FIGS. 13A and 13B are diagrams showing optical characteristics (MTF and lateral aberration) of design example 1;

FIGS. 14A and 14B are diagrams showing optical characteristics (field curvature, distortion, and longitudinal aberration) of design example 1;

FIGS. 15A and 15B are diagrams showing optical characteristics (MTF and lateral aberration) of design example 2;

FIGS. 16A and 16B are diagrams showing optical characteristics (field curvature, distortion, and longitudinal aberration) of design example 2;

FIGS. 17A and 17B are diagrams showing optical characteristics (MTF and lateral aberration) of design example 3;

FIGS. 18A and 18B are diagrams showing optical characteristics (field curvature, distortion, and longitudinal aberration) of design example 3;

FIGS. 19A and 19B are diagrams showing optical characteristics (MTF and lateral aberration) of design example 4;

FIGS. 20A and 20B are diagrams showing optical characteristics (field curvature, distortion, and longitudinal aberration) of design example 4;

FIGS. 21A and 21B are diagrams showing optical characteristics (MTF and lateral aberration) of design example 5;

FIGS. 22A and 22B are diagrams showing optical characteristics (field curvature, distortion, and longitudinal aberration) of design example 5;

FIGS. 23A and 23B are diagrams showing optical characteristics (MTF and lateral aberration) of design example 6;

FIGS. 24A and 24B are diagrams showing optical characteristics (field curvature, distortion, and longitudinal aberration) of design example 6;

FIGS. 25A and 25B are diagrams showing optical characteristics (MTF and lateral aberration) of design example 7;

FIGS. 26A and 26B are diagrams showing optical characteristics (field curvature, distortion, and longitudinal aberration) of design example 7;

FIGS. 27A and 27B are diagrams showing optical characteristics (MTF and lateral aberration) of design example 8;

FIGS. 28A and 28B are diagrams showing optical characteristics (field curvature, distortion, and longitudinal aberration) of design example 8;

FIGS. 29A and 29B are diagrams showing optical characteristics (MTF and lateral aberration) of design example 9;

FIGS. 30A and 30B are diagrams showing optical characteristics (field curvature, distortion, and longitudinal aberration) of design example 9;

FIGS. 31A and 31B are diagrams showing optical characteristics (MTF and lateral aberration) of design example 10;

FIGS. 32A and 32B are diagrams showing optical characteristics (field curvature, distortion, and longitudinal aberration) of design example 10;

FIGS. 33A to 33C are diagrams showing manufacturing tolerances (first to third lens elements) in comparative example;

FIGS. 34A and 34B are diagrams showing manufacturing tolerances (fourth and fifth lens elements) in comparative example;

FIGS. 35A to 35C are diagrams showing manufacturing tolerances (first to third lens elements) in design example 1;

FIGS. 36A and 36B are diagrams showing manufacturing tolerances (fourth and fifth lens elements) in design example 1;

FIGS. 37A to 37C are diagrams showing manufacturing tolerances (first to third lens elements) in design example 2;

FIGS. 38A and 38B are diagrams showing manufacturing tolerances (fourth and fifth lens elements) in design example 2;

FIGS. 39A to 39C are diagrams showing manufacturing tolerances (first to third lens elements) in design example 3;

FIGS. 40A and 40B are diagrams showing manufacturing tolerances (fourth and fifth lens elements) in design example 3;

FIGS. 41A to 41C are diagrams showing manufacturing tolerances (first to third lens elements) in design example 4;

FIGS. 42A and 42B are diagrams showing manufacturing tolerances (fourth and fifth lens elements) in design example 4;

FIGS. 43A to 43C are diagrams showing manufacturing tolerances (first to third lens elements) in design example 5;

FIGS. 44A and 44B are diagrams showing manufacturing tolerances (fourth and fifth lens elements) in design example 5;

FIGS. 45A to 45C are diagrams showing manufacturing tolerances (first to third lens elements) in design example 6;

FIGS. 46A and 46B are diagrams showing manufacturing tolerances (fourth and fifth lens elements) in design example 6;

FIGS. 47A to 47C are diagrams showing manufacturing tolerances (first to third lens elements) in design example 7;

FIGS. 48A and 48B are diagrams showing manufacturing tolerances (fourth and fifth lens elements) in design example 7;

FIGS. 49A to 49C are diagrams showing manufacturing tolerances (first to third lens elements) in design example 8;

FIGS. 50A and 50B are diagrams showing manufacturing tolerances (fourth and fifth lens elements) in design example 8;

FIGS. 51A to 51C are diagrams showing manufacturing tolerances (first to third lens elements) in design example 9;

FIGS. 52A and 52B are diagrams showing manufacturing tolerances (fourth and fifth lens elements) in design example 9;

FIGS. 53A to 53C are diagrams showing manufacturing tolerances (first to third lens elements) in design example 10;

FIGS. 54A and 54B are diagrams showing manufacturing tolerances (fourth and fifth lens elements) in design example 10;

FIG. 55 is a diagram showing parameter values in prior art examples; and

FIG. 56 is a diagram showing a configuration example of an imaging device loaded with the imaging lens according to the embodiment.

The drawings are provided mainly for describing the present invention, and do not limit the scope of the present invention.

### DESCRIPTION OF PREFERRED EMBODIMENTS

### 1. Embodiment

In the following, an embodiment of the invention is described referring to the drawings. The embodiment is an example, in which the invention is applied to an imaging lens for a camera to be loaded in a mobile phone or a like device, and to an imaging device to be loaded in a camera for a mobile phone.

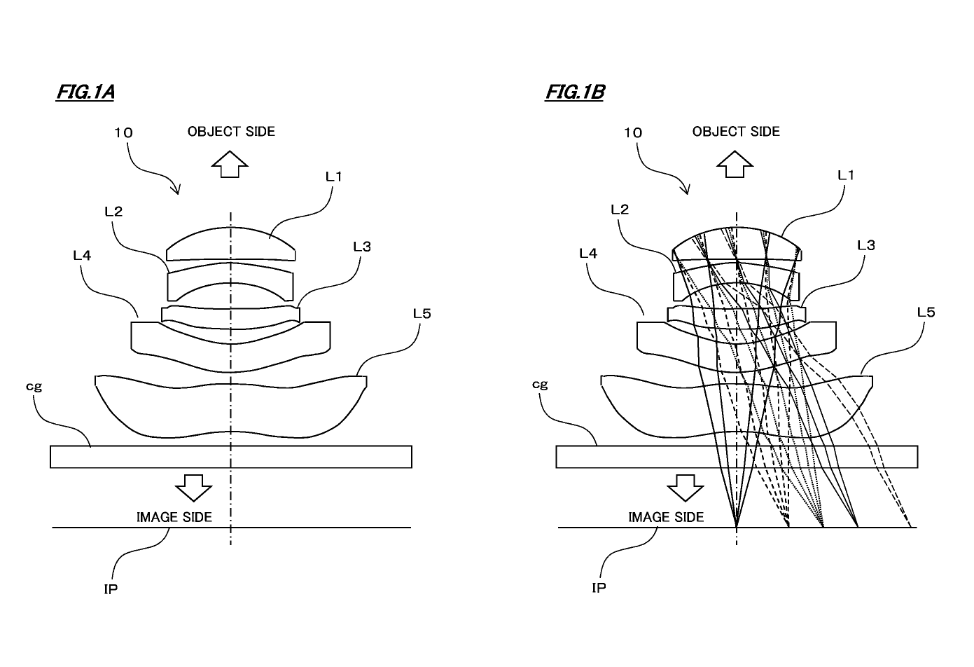

FIG. 1A is a diagram showing a configuration of an imaging lens 10 according to an embodiment, and FIG. 1B is a diagram schematically showing that part of light rays is added to the imaging lens 10 shown in FIG. 1A.

As shown in FIG. 1A, the imaging lens 10 includes five lens elements i.e. a first lens element L1, a second lens element L2, a third lens element L3, a fourth lens element L4, and a fifth lens element L5. Each of the first to fifth lens elements L1 to L5 has a circular lens area with an optical axis thereof as a center. The symbol cg denotes a cover glass which covers a light receiving surface of an imaging sensor element (not shown). The light receiving surface of the imaging sensor element is disposed on an image plane IP of the imaging lens 10.

The first lens element L1 is a meniscus lens element having a positive refractive power and having a convex surface toward the object side. The second lens element L2 is a meniscus lens element having a negative refractive power and having a concave surface toward the image side. The third lens element L3 is a meniscus lens element having a positive refractive power and having a convex surface toward the image side. The fourth lens element L4 is a meniscus lens element having a negative refractive power and having a convex surface toward the image side. The fifth lens element L5 is a meniscus lens element having a concave surface toward the image side. In this embodiment, as will be described later, the fifth lens element L5 may have either one of a positive refractive power and a negative refractive power depending on the purpose of use. Further, the first lens element L1 and the third lens element L3 may be a biconvex lens element having a positive refractive power.

The first to fifth lens elements L1 to L5 correct chromatic aberrations and other aberrations generated in light formed on the image plane IP, as described in the following. Specifically, regarding chromatic aberrations, the second lens element L2 corrects on-axis chromatic aberration, and the fourth lens element L4 corrects on-axis chromatic aberration and magnification chromatic aberration. Further, regarding the other aberrations, the fourth lens element L4 and the fifth lens element L5 mainly correct field curvature and distortion, and the first lens element L1, the second lens element L2, and the third lens element L3 correct spherical aberration and coma aberration.

In the following, the features of each of the lens elements constituting the imaging lens 10 are described in detail.

### First Lens Element L1

In the case of implementing the fast imaging lens 10 with a small F-number, the lens diameter of each of the lens elements may be increased. In this embodiment, as described above, the first lens element L1 and the third lens element L3 have a positive refractive power. Accordingly, an increase in the lens diameter of the first lens element L1 and the third lens element L3 makes it difficult to secure a thickness of an edge of the first lens element L1 and the third lens element L3. On the other hand, it is necessary to secure a predetermined thickness or more as the thickness of the edge of the first lens element L1 and the third lens element L3 in order to properly mount the first lens element L1 and the third lens element L3 on a lens holder (lens barrel). In view of the above, in this embodiment, the first lens element L1 is a meniscus lens element, thereby securing the thickness of the edge of the first lens element L1.

The third lens element L3 is located on the image plane IP side than the first lens element L1. Accordingly, as shown in FIG. 1B, light with a large viewing angle may enter the third lens element L3. The lens diameter of the third lens element L3 is normally larger than the lens diameter of the first lens element L1 so that light of such a large viewing angle can be transmitted. As a result, it is further difficult to secure a thickness of an edge of the third lens element L3, as compared with the first lens element L1. In view of the above, in this embodiment, out of the first lens element L1 and the third lens element L3 to which a positive refractive power is given, the positive refractive power given to the third lens element L3 is made small, and the positive refractive power given to the first lens element L1 is made large. The above configuration makes it possible to reduce the curvature of the third lens element L3. This is more advantageous in securing a thickness of an edge of the third lens element L3.

### Third Lens Element L3

As described above, the thickness of the edge of the third lens element L3 is secured by suppressing the positive refractive power given to the third lens element L3. Further, in this embodiment, as described above, the third lens element L3 is also a meniscus lens element. The above configuration is more advantageous in securing the thickness of the edge of the third lens element L3.

In this example, it is desirable to set the positive refractive power of the third lens element L3 so as to satisfy the following conditional expression.

f3/f≧1.4 (1)

where f3 denotes a focal length of the third lens element L3, and f denotes a focal length of the imaging lens 10. In design examples to be described later, the positive refractive power of the third lens element L3 is set according to the conditional expression (1). This is advantageous in implementing the fast and low-height imaging lens 10.

Further, as described above, the third lens element L3 is a meniscus lens element having a convex surface toward the image side. According to this configuration, as will be described later, it is possible to obtain an advantage that the distance between the third lens element L3 and the fourth lens element L4 in the optical axis direction can be shortened. Specifically, in this embodiment, the fourth lens element L4 is a meniscus lens element having a negative refractive power and having a convex surface toward the image side. Accordingly, as approaching toward the outer periphery of the fourth lens element L4, the object-side lens surface of the fourth lens element L4 is inclined toward the object side, and gradually comes close to the image-side lens surface of the third lens element L3. In view of the above, it is necessary to set the distance between the third lens element L3 and the fourth lens element L4 wide enough to avoid the contact between the object-side lens surface of the fourth lens element L4 and the image-side lens surface of the third lens element L3.

Contrary to the above, in this embodiment, the third lens element L3 is a meniscus lens element having a convex surface toward the image side. Accordingly, as approaching toward the outer periphery of the third lens element L3, the image-side lens surface of the third lens element L3 is away from the object-side lens surface of the fourth lens element L4. According to this configuration, the contact between the image-side lens surface of the third lens element L3 and the object-side lens surface of the fourth lens element L4 is avoided. The above configuration makes it possible to bring the image-side lens surface of the third lens element L3 and the object-side lens surface of the fourth lens element L4 in proximity to each other. As a result, it is possible to shorten the distance between the third lens element L3 and the fourth lens element L4 in the optical axis direction. Thus, the above configuration is advantageous in reducing the entire size of the imaging lens in the optical axis direction.

Further, the object-side lens surface and the image-side lens surface of the third lens element L3 have such a shape that the curvature thereof decreases, as approaching from the center of the third lens element L3 toward the periphery thereof. According to this configuration, as described in the following, it is possible to suppress field curvature and astigmatism, which may be generated in light transmitting through a peripheral portion of the third lens element L3.

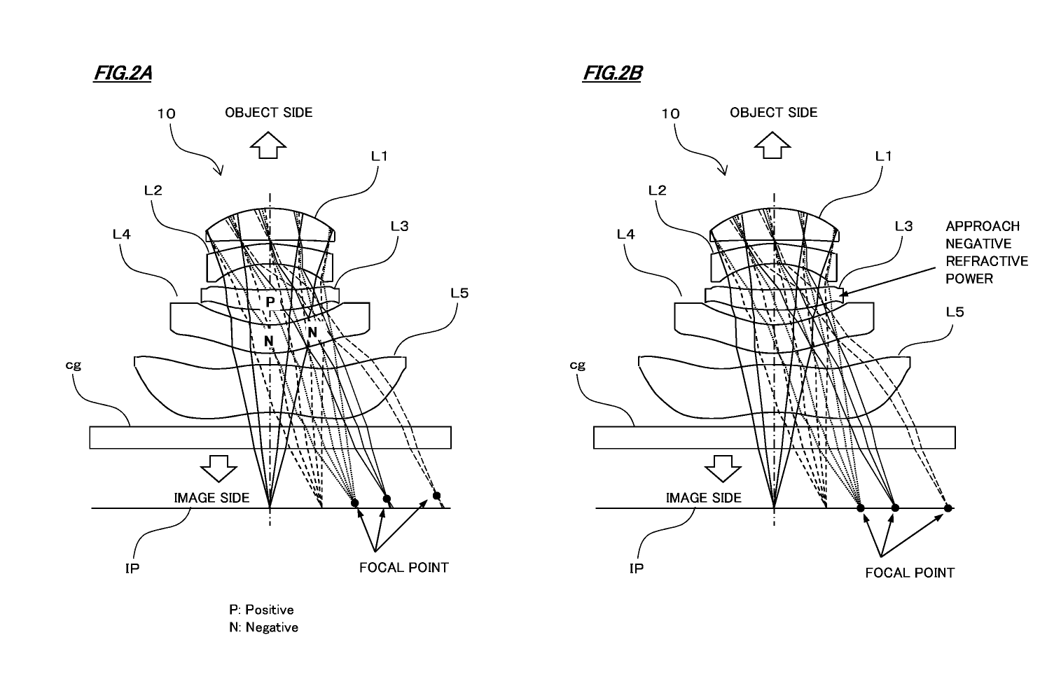

In this embodiment, the fourth lens element L4 has a negative refractive power in order to correct on-axis chromatic aberration and magnification chromatic aberration by the fourth lens element L4. Accordingly, it is impossible to make the curvature of the image-side lens surface (convex surface) of the fourth lens element L4 large. On the other hand, as shown in FIG. 2A, configuring the fourth lens element L4 to have a negative refractive power as described above results informing a focal point of light transmitting through the peripheral portion of the third lens element L3 to the fifth lens element L5 at a position forward of the image plane IP. As a result, field curvature and astigmatism may be generated in the light.

In view of the above, in this embodiment, the object-side lens surface and the image-side lens surface of the third lens element L3 have such a shape that the curvature thereof decreases, as approaching from the center of the third lens element L3 toward the periphery thereof so that the positive refractive power of the peripheral portion of the third lens element L3 comes close to the negative refractive power. According to this configuration, as shown in FIG. 2B, the focal point of light transmitting through the peripheral portion of the third lens element L3 comes close to the image plane IP, thereby correcting field curvature and astigmatism generated in the light.

Further, in this embodiment, it is desirable to configure the third lens element L3 so as to satisfy the following conditional expression.

R6/CT3<−5 (2)

where R6 denotes a curvature radius of the image-side lens surface of the third lens element L3, and CT3 denotes a center thickness (thickness on the optical axis) of the third lens element L3.

An investigation by the inventor of the present application reveals that designing the imaging lens 10 in such a manner that the third lens element L3 satisfies the design condition: −4.5<R6/CT3<−0.5 results in an increase of the thickness of the third lens element L3 and a short flange back length. Further, it has been found that a reduction in the lens diameter in order to make R6 (curvature radius) large results in insufficient correction of field curvature and astigmatism. As will be described later in design examples, designing the imaging lens 10 in such a manner that the third lens element L3 satisfies the condition: R6/CT3<−5.0 makes it possible to secure a long flange back length and to properly correct field curvature and astigmatism. In view of the above, it is desirable to configure the third lens element L3 so as to satisfy the conditional expression (2).

Further, the third lens element L3 may be a biconvex lens element having a positive refractive power. According to this configuration, it is possible to distribute the positive power to the object-side surface and the image-side surface of the third lens element L3. This is advantageous in alleviating the requirements on manufacturing tolerances with respect to optical axis misalignment between the object-side surface and the image-side surface of the third lens element L3.

### Fourth Lens Element L4

In this embodiment, as described above, it is desirable to configure the fourth lens element L4 to have a negative refractive power, and that the refractive power of the fourth lens element L4 satisfies the following conditional expression.

f3>|f4| (3)

where f3 denotes a focal length of the third lens element L3, and f4 denotes a focal length of the fourth lens element L4. In design example 9 to be described later, the negative refractive power of the fourth lens element L4 is set to satisfy the conditional expression (3). According to this configuration, the negative power of the fourth lens element L4 is increased. This makes it possible to weaken the negative paraxial power of the second lens element L2 and makes it possible to alleviate the requirements on manufacturing tolerances of the second lens element L2. Further, the above configuration makes it possible to make the curvature radius of the image-side surface of the second lens element L2 large. This is advantageous in securing a space between the second lens element L2 and the third lens element L3.

### Fifth Lens Element L5

In the case where an imaging lens is constituted of five lens elements, generally, the fifth lens element closest to the image plane is configured to have a positive refractive power on a peripheral portion thereof for correcting aberrations. In this embodiment, the peripheral portion of the fifth lens element L5 has a positive refractive power for substantially the same reason as described above. In this embodiment, however, it is decided whether the central portion of the fifth lens element L5 has a positive refractive power or a negative refractive power according to the following design concept, as necessary.

Firstly, in the case where it is necessary to suppress an increase in the flange back length, it is desirable to give a positive power to the central portion of the fifth lens element L5. In this embodiment, since the second lens element L2 and the fourth lens element L4 have a negative refractive power, the flange back length tends to excessively increase. In view of the above, it is desirable to shorten the flange back length as much as possible by giving a positive refractive power to the central portion of the fifth lens element L5 in order to avoid an excessive increase in the flange back length. On the other hand, in the case where it is not necessary to suppress an increase in the flange back length, it is desirable to give a negative power to the central portion of the fifth lens element L5. In the aspect of correcting aberrations, generally, it is preferable to switch the refractive power, between the lens element closest to the image side and a lens element anterior to the lens element, from a positive refractive power to a negative refractive power, or from a negative refractive power to a positive refractive power. This makes it possible to design a lens capable of easily correcting aberrations. In this embodiment, although the central portion of the fourth lens element L4 has a negative refractive power, a positive refractive power is given to the central portion of the third lens element L3. Accordingly, giving a negative refractive power to the central portion of the fifth lens element L5 makes it possible to design a lens capable of easily correcting aberrations, in view of the relationship between a positive refractive power of the third lens element L3 and a negative refractive power of the fifth lens element L5.

As described above, it is desirable to give a negative refractive power to the central portion of the fifth lens element L5 in the aspect of correcting aberrations and improving optical characteristics. On the other hand, it is desirable to give a positive refractive power to the central portion of the fifth lens element L5 in the aspect of suppressing an excessive increase in the flange back length. In the case of giving a positive refractive power to the central portion of the fifth lens element L5, however, the optical characteristics may be slightly deteriorated.

It is desirable to set the refractive power of the fifth lens element L5 so as to satisfy the following conditional expression.

|f/f5|≦0.1 (4)

where f denotes a focal length of the imaging lens 10, and f5 denotes a focal length of the fifth lens element L5. Design examples to be described later satisfy the conditional expression (4).

### Aperture Stop

An aperture stop is further provided in the imaging lens 10 shown in FIG. 1A. The aperture stop is constituted of a circular opening, and a light blocking portion formed around the opening. The aperture stop is disposed in such a manner that the center of the opening coincides with the optical axis of the imaging lens 10. In this embodiment, the aperture stop is disposed on the object side than the image-side lens surface of the third lens element L3, which is disposed at the third position from the object side. Specifically, the aperture stop is disposed on the object side of the first lens element L1, between the first lens element L1 and the second lens element L2, or between the second lens element L2 and the third lens element L3.

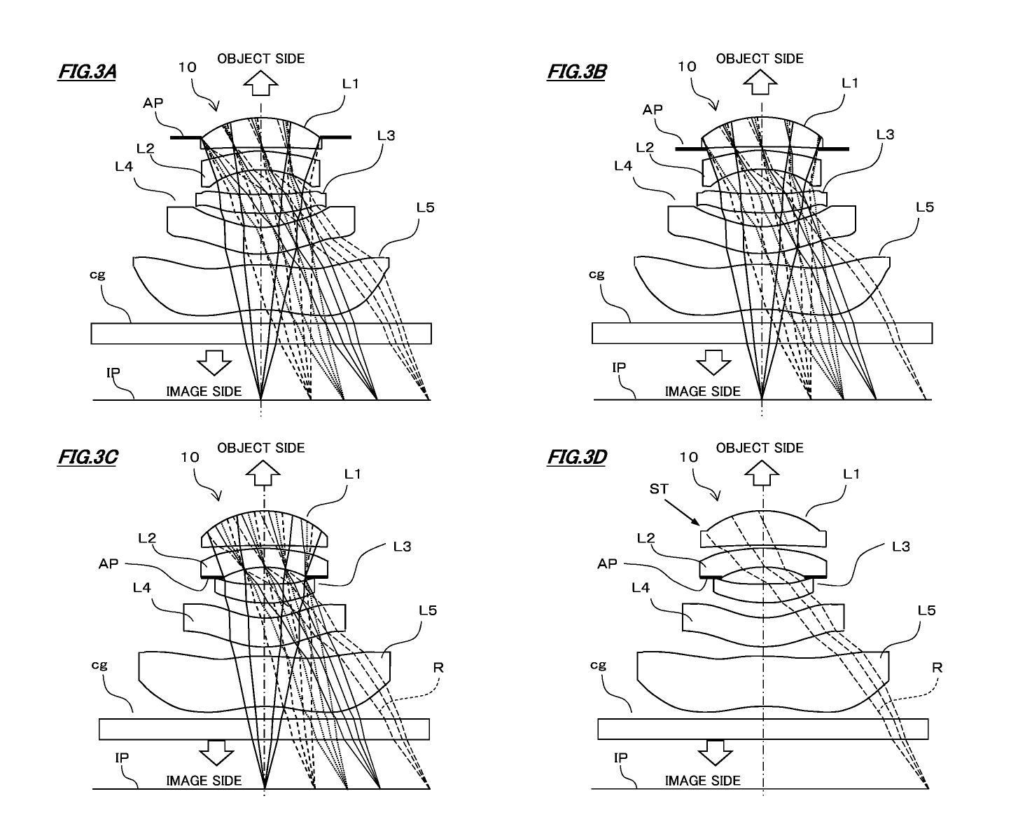

FIG. 3A is a diagram showing a configuration example of the imaging lens 10, in the case where an aperture stop AP is disposed on the object side of the first lens element L1. FIG. 3B is a diagram showing a configuration example of the imaging lens 10, in the case where an aperture stop AP is disposed between the first lens element L1 and the second lens element L2. FIG. 3C is a diagram showing a configuration example of the imaging lens 10, in the case where an aperture stop AP is disposed between the second lens element L2 and the third lens element L3. In FIGS. 3A to 3C, part of light rays transmitting through the imaging lens 10 is schematically shown.

As will be described later in design examples, configuring the first to fifth lens elements L1 to L5 as described above makes it possible to design the fast and low-height imaging lens 10 whose F-number is 2.4 or less, with a long flange back length and less requirements on manufacturing tolerances, no matter at which position shown in FIGS. 3A to 3C, the aperture stop AP is disposed.

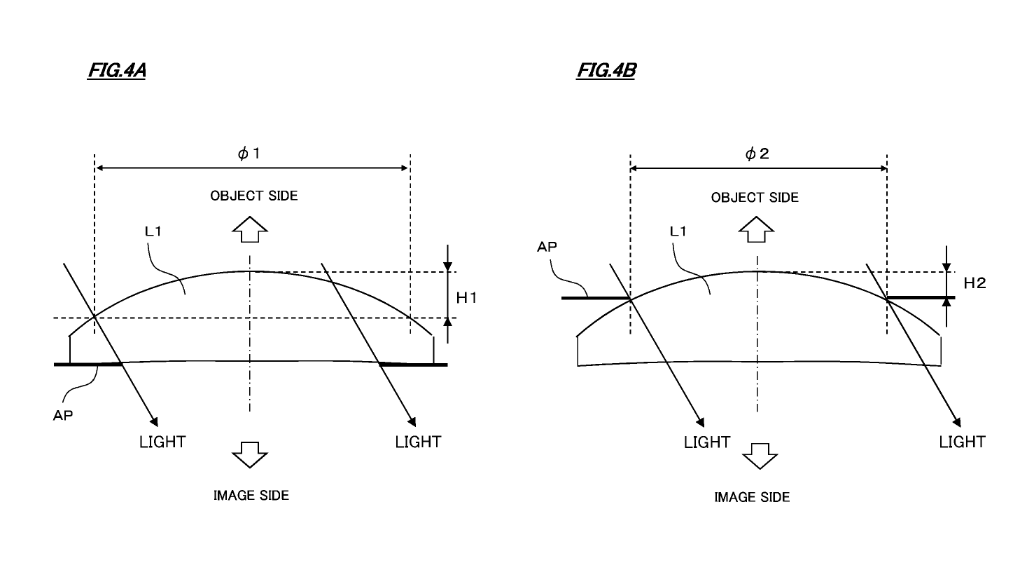

Further, as shown in FIG. 3A, disposing the aperture stop AP on the object side of the first lens element L1 is further advantageous in securing an edge thickness of the first lens element L1. For instance, as shown in FIG. 4A, in the case where the aperture stop AP is disposed between the first lens element L1 and the second lens element L2, it is necessary to widen the effective diameter φ1 of the object-side lens surface of the first lens element L1 so as to transmit light passing through the aperture stop AP obliquely. On the other hand, as shown in FIG. 4B, in the case where the aperture stop AP is disposed on the object side of the first lens element L1, it is possible to make the effective diameter φ2 of the object-side lens surface of the first lens element L1 to be substantially equal to the diameter of the aperture stop AP. Thus, with use of the effective diameter φ2, it is possible to secure an F-number substantially the same as in the configuration shown in FIG. 4A.

Accordingly, as shown in FIG. 4B, disposing the aperture stop AP on the object side of the first lens element L1 makes it possible to reduce the effective diameter φ2 of the object-side lens surface of the first lens element L1, as compared with the effective diameter φ1, while securing an F-number substantially as fast as in the configuration shown in FIG. 4A. This makes it possible to reduce the height H2 of the effective diameter, as compared with the height H1 in the configuration shown in FIG. 4A. This is advantageous in securing an edge thickness of the first lens element L1 by the amount corresponding to the reduction. The above advantageous is obtained substantially in the same manner as in a configuration, in which the first lens element L1 is not a meniscus lens element but a convex lens element.

Further, as shown in FIG. 3C, disposing the aperture stop AP between the second lens element L2 and the third lens element L3 is further advantageous in alleviating the requirements on manufacturing tolerances, as compared with the configuration shown in FIGS. 3A and 3B. This will be described later in design examples.

### Field Stop

Setting the F-number to 2.2 or less in order to secure the fast imaging lens 10 may make it difficult to correct aberrations generated in light transmitting through the peripheral portion of the first to fifth lens elements L1 to L5. In order to solve this drawback, it is desirable to dispose an element (so-called field stop) for cutting light transmitting through the peripheral portion of the first to fifth lens elements L1 to L5.

The field stop can be implemented by disposing a light blocking portion on a film to be inserted between lens elements. Alternatively, the field stop can be implemented by omitting a lens function from a lens peripheral area (light blocking area) and by making the lens peripheral area to coincide with a plane perpendicular to the optical axis, for instance.

An investigation by the inventor of the present application reveals that, in the case where the F-number is set to 2.0 in the imaging lens 10 of this embodiment, it is desirable to cut, with use of a field stop, about 10 to 25% of the light amount guided to the image plane IP in the case where the light rays impinging on the peripheral portion are not cut. Further, it has been found that in the case where the F-number is set to 2.2, it is desirable to cut, with use of a field stop, about 5 to 15% of the light amount guided to the image plane IP in the case where the light rays impinging on the peripheral portion are not cut.

Disposing the field stop as described above eliminates the need of providing a lens surface on the peripheral area where light is cut. Accordingly, as described above, it is possible to make the peripheral area to coincide with a plane perpendicular to the optical axis. This is also advantageous in securing an edge thickness of a lens element. In view of the above, it is desirable to provide a field stop with respect to the first lens element L1 or with respect to the third lens element L3, whose edge thickness tends to be small. In the above configuration, the field stop is disposed on the object side or the image side of the first lens element L1, or is disposed on the object side or the image side of the third lens element L3.

In the case where the aperture stop AP is disposed between the second lens element L2 and the third lens element L3, as shown in FIG. 3C, it is desirable to dispose the field stop on the object side than the object-side surface of the second lens element L2. In the above configuration, for instance, as shown in FIG. 3D, the field stop ST is disposed on the object-side lens surface of the first lens element L1. In this example, the field stop ST is formed by making the outer periphery of the object-side lens surface of the first lens element L1 to coincide with a plane perpendicular to the optical axis over the entire circumference thereof. According to this configuration, light rays R shown in FIG. 3D are cut, whereby aberrations generated in light transmitting through the peripheral portion of the imaging lens 10 are suppressed. Further, the above configuration eliminates the need of providing a lens surface on the peripheral portion of the object-side lens surface of the first lens element L1. This is advantageous in securing an edge thickness of the first lens element L1 by making the field stop ST to coincide with a plane perpendicular to the optical axis, as shown in FIG. 3D, for instance.

Further, it is desirable to dispose a film-like field stop between the respective lens elements i.e. between the first to fifth lens elements L1 to L5.

In addition, it is further desirable to dispose a film-like field stop between the first lens element and the third lens element, and not to dispose a film-like field stop between the third lens element and the fifth lens element. This is because, in the case where a film-like field stop is disposed between the third lens element and the fifth lens element, reflected light from the film may cause flare, and it may be difficult to form an image of a high quality.

### 2. Design Examples and Comparative Example

In the following, practical design examples (design examples) of the imaging lens 10 having the aforementioned configuration are described in contrast with comparative example. Comparative example has the following configuration.

first lens element L1 . . . a meniscus lens element having a positive refractive power and having a convex surface toward the object side

second lens element L2 . . . a biconcave lens element having a negative refractive power

third lens element L3 . . . a meniscus lens element having a positive refractive power and having a convex surface toward the object side

fourth lens element L4 . . . a meniscus lens element having a positive refractive power and having a convex surface toward the image side

fifth lens element L5 . . . a biconcave lens element having a negative refractive power

Comparative example is an example uniquely configured by the inventor of the present application, based on the configuration of the imaging lens disclosed in Japanese Patent No. 4,947,237 (corresponding to U.S. Pat. No. 8,462,257).

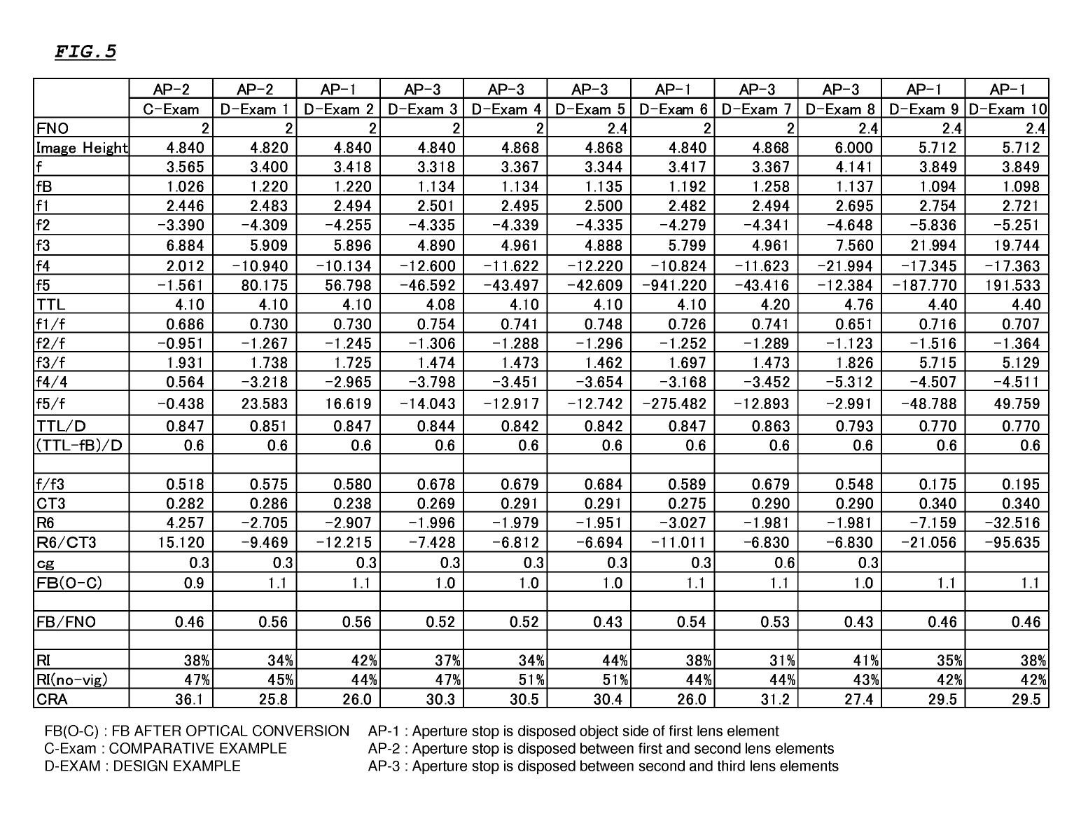

FIG. 5 is a diagram showing parameter values in design examples of the imaging lens 10 and in comparative example. FIG. 5 shows parameter values in ten design examples i.e. design examples 1 to 10, as design examples of the imaging lens 10 according to the embodiment. FIG. 5 also shows parameter values in comparative example.

### Design Condition

Firstly, the design condition of the inventive design examples is described referring to the table shown in FIG. 5.

In the table shown in FIG. 5, the left end column indicates the parameters to be included in the design condition of the inventive design examples. In the left end column, FNO denotes an F-number of the imaging lens, f denotes a focal length of the imaging lens, fB denotes a flange back length (to be described later) before optical conversion, f1 to f5 denote focal lengths of the first to fifth lens elements in the order from the object side, TTL denotes a distance (to be described later) between the image plane and the lens surface of the imaging lens closest to the object side, D denotes a diagonal length (to be described later) of the image size, CT3 denotes a center thickness of the third lens element from the object side, R6 denotes a curvature radius of the sixth lens surface from the object side (image-side lens surface of the third lens element from the object side), cg denotes a thickness of the cover glass, FB denotes a value (to be described later) of the flange back length fB after optical conversion, RI and RI (no vignetting) denote peripheral light amount ratios (to be described later), and CRA denotes a maximum incident angle of light ray with respect to the image plane.

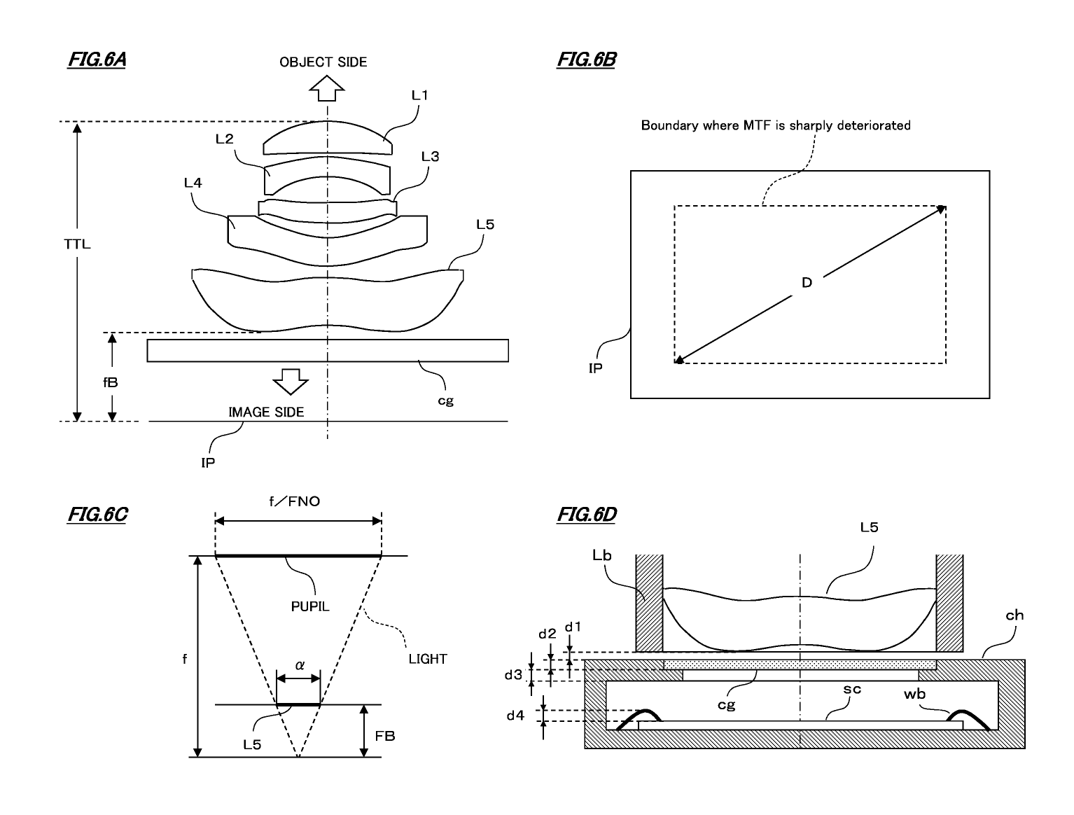

FIG. 6A is a diagram describing a method for defining TTL and fB (flange back length). FIG. 6A shows TTL and fB of the imaging lens 10 of the embodiment. Further, FIG. 6B is a diagram showing a diagonal length D of the image size.

As shown in FIG. 6A, TTL indicates a distance between the image plane IP and an outermost surface of the object-side lens surface of the lens element (in this example, first lens element L1) closest to the object side; and fB indicates a distance between the image plane IP and an outermost surface (position closest to the image plane IP) of the image-side lens surface of the lens element (in this example, fifth lens element L5) closest to the image side. As shown in FIG. 6B, D indicates a diagonal length of a rectangular area (image size) where MTF is properly maintained with respect to the light formed on the image plane IP and received by the image sensor, and corresponds to “image height” in FIG. 5. RI and RI (no vignetting) indicate light amount ratios (peripheral light amount ratio=light amount on peripheral portion/light amount on central portion) of light incident on the central portion and the peripheral portion of the rectangular area (image size). RI indicates a peripheral light amount ratio in the case where light on the peripheral portion of the lens element is cut (vignetted) by the field stop, and RI (no vignetting) indicates a peripheral light amount ratio in the case where a field stop is not provided.

Referring to FIG. 6A, the cover glass cg is disposed between the lens element (in this example, fifth lens element L5) closest to the image side and the image plane IP. Accordingly, the optical path length in transmitting light through the cover glass cg changes from a geometric optical path length due to a refractive function of the cover glass cg. As a result, the optical flange back length also changes from a geometric flange back length depending on the thickness of the cover glass cg.

In the table shown in FIG. 5, fB denotes a geometric flange back length, and FB denotes an optical flange back length. FB is obtained according to the following equation, with use of fB and the thickness cg of the cover glass.

FB=fB−cg+(cg/Ncg) (5)

where Ncg denotes a refractive index of the cover glass. In this example, Ncg is set to 1.5163.

In the inventive design examples, the imaging lens 10 is designed to satisfy the following conditional expressions, with use of the aforementioned parameters.

FNO<2.6 (6)

(TTL−fB)/D≦0.6 (7)

FB/FNO≧0.4 (8)

FB≧1.0 (9)

In this example, the conditional expression (6) defines the fastness which the imaging lens 10 should satisfy, and the conditional expression (7) defines the height (length in the optical axis direction) which the imaging lens 10 should satisfy. Referring to FIG. 6A, the height of the imaging lens 10 is defined by (TTL−fB). However, in the conditional expression (7), the design condition is defined with use of (TTL−fB)/D. This is because, generally, as the image size increases, the height of the imaging lens 10 increases. In view of the above, standardizing the height (TTL−fB) of the imaging lens 10 with use of the diagonal length D of the image size makes it possible to evaluate the height of the imaging lens 10 regardless of the magnitude of the image size.

Further, the conditional expression (8) is used for defining the flange back length. In the inventive design examples, the conditional expression (8) is defined according to the following idea.

FIG. 6C is a diagram schematically showing a light collecting state of the imaging lens 10. Referring to FIG. 6C, assuming that f denotes a focal length of the imaging lens 10 and FNO denotes an F-number of the imaging lens 10 as described above, the diameter of entrance pupil of the imaging lens 10 is represented by f/FNO. Assuming that α denotes a diameter of a light transmitting area on the image-side lens surface of the fifth lens element L5, α is expressed by the following equation, with use of the flange back length FB.

α=FB/FNO (10)

Taking into consideration of a case, in which dust is adhered to the image-side lens surface of the fifth lens element L5, the size of dust adhered to the lens surface is normally 1 to 10 μm. Generally, it is said that an influence of dust may appear on a captured image, in the case where the size of dust adhered to the image-side lens surface of the fifth lens element L5 exceeds about 5% of the surface area of a light transmitting area on the image-side lens surface of the fifth lens element L5. On the other hand, the surface area of a light transmitting area on the image-side lens surface of the fifth lens element L5 increases, as the diameter α in the equation (10) increases. In view of the above, even if dust of a largest possible and adherable size (10 μm) adheres to the image-side lens surface of the fifth lens element L5, as far as the surface area of the dust does not exceed 5% of the surface area of a light transmitting area defined by the diameter α, it is less likely that the dust may affect a captured image. Thus, as far as the diameter α (=FB/FNO) of a light transmitting area on the image-side lens surface of the fifth lens element L5 satisfies the aforementioned equation (8), there is no or less likelihood that the surface area of the dust exceeds 5% of the surface area of the light transmitting area, and that the dust affects a captured image, even if dust in the size of 10 μm is adhered to the image-side lens surface of the fifth lens element L5.

Accordingly, setting the flange back length FB long enough to satisfy the conditional expression (8) makes it possible to avoid an influence of dust on a captured image.

As described above, the conditional expression (8) defines the flange back length FB, taking into consideration of an influence of dust on a captured image.

FIG. 6D is a diagram describing the conditional expression (9). FIG. 6D schematically shows a peripheral portion of the cover glass cg in an imaging device incorporated with the imaging lens 10. Referring to FIG. 6D, Lb denotes a lens barrel, ch denotes a cover glass holder, sc denotes a sensor chip (image sensor), and wb denotes a wire bonding for electrically connecting the sensor chip sc to a circuit board.

In a state that the imaging lens 10 is incorporated in an imaging device, normally, there is formed a clearance d1 between the lens barrel Lb (position of the fifth lens element L5 closest to the image side) and the cover glass holder ch in order to prevent collision between the fifth lens element L5 and the cover glass cg in adjusting the focus of the imaging lens 10, for instance. Further, it is necessary to secure a thickness d3 of a support portion of the cover glass cg in order to properly support the cover glass cg. Furthermore, it is necessary to secure a clearance d4 between the apex portion of the wire bonding wb and the top surface of the sensor chip sc in order to dispose the wire bonding wb. The symbol d2 denotes an optical thickness of the cover glass cg.

In the case where the imaging lens 10 is loaded in a camera for a mobile phone as described in the embodiment, it is necessary to secure at least about 0.2 mm for the clearance d1, it is necessary to secure at least about 0.3 mm for the thickness d3, and it is necessary to secure about 0.3 mm for the clearance d4. Further, in the case where the thickness of the cover glass cg is 0.3 mm, the thickness of the cover glass cg after optical conversion is about 0.2 mm. Accordingly, based on the sum of these values, it is necessary to set the distance from the image-side surface of the fifth lens element L5 to the image plane (light receiving surface of the sensor chip sc) to at least 1.0 mm. Therefore, it is necessary to secure a length equal to or longer than the aforementioned distance (1.0 mm) for the flange back length FB, and to satisfy the conditional expression (9).

The aforementioned description about the flange back length FB is a description about a sensor structure called COB, in which a wire is directly mounted on a sensor. The same idea is also applied to e.g. a sensor structure called CSP, in which a cover glass is adhered to the object-side surface of a sensor surface, and a wire is mounted from the image side of the sensor surface.

### <Configuration of Comparative Example and Design Examples>

The uppermost row of the table shown in FIG. 5 indicates the positions of aperture stops in comparative example and in design examples 1 to 10. Specifically, in comparative example and in design examples 1 to 10, the aperture stops are disposed at the following positions.

Comparative example . . . between the first lens element L1 and the second lens element L2

Design example 1 . . . between the first lens element L1 and the second lens element L2

Design example 2 . . . on the object side of the first lens element L1

Design example 3 . . . between the second lens element L2 and the third lens element L3 (the image-side surface of the second lens element L2 also serves as an aperture stop)

Design example 4 . . . between the second lens element L2 and the third lens element L3

Design example 5 . . . between the second lens element L2 and the third lens element L3

Design example 6 . . . on the object side of the first lens element L1

Design example 7 . . . between the second lens element L2 and the third lens element L3

Design example 8 . . . between the first lens element L1 and the second lens element L2

Design example 9 . . . on the object side of the first lens element L1

Design example 10 . . . on the object side of the first lens element L1

Further, the following is the lens configuration of each of design examples.

### Design Example 1

first lens element L1 . . . a biconvex lens element having a positive refractive power

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 2

first lens element L1 . . . a biconvex lens element having a positive refractive power

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 3

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 4

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 5

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 6

first lens element L1 . . . a biconvex lens element having a positive refractive power

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 7

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 8

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 9

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a meniscus lens element having a positive refractive power and having a convex surface toward the image side

fourth lens element L4 . . . a meniscus lens element having a negative refractive power and having a convex surface toward the image side

fifth lens element L5 . . . a meniscus lens element having a negative refractive power and having a concave surface toward the image side

### Design Example 10

first lens element L1 . . . a meniscus lens element having a positive refractive power and having a convex surface toward the object side

second lens element L2 . . . a meniscus lens element having a negative refractive power and having a concave surface toward the image side

third lens element L3 . . . a biconvex lens element having a positive refractive power

fourth lens element L4 . . . a meniscus lens element having a negative refractive power and having a convex surface toward the image side

fifth lens element L5 . . . a meniscus lens element having a negative refractive power and having a concave surface toward the image side

Further, in comparative example and in design examples 1 to 6 and 8 to 10, the thickness of the cover glass cg is 0.3 mm; and in design example 7, the thickness of the cover glass cg is 0.6 mm.

### <Design Values in Comparative Example and Design Examples>

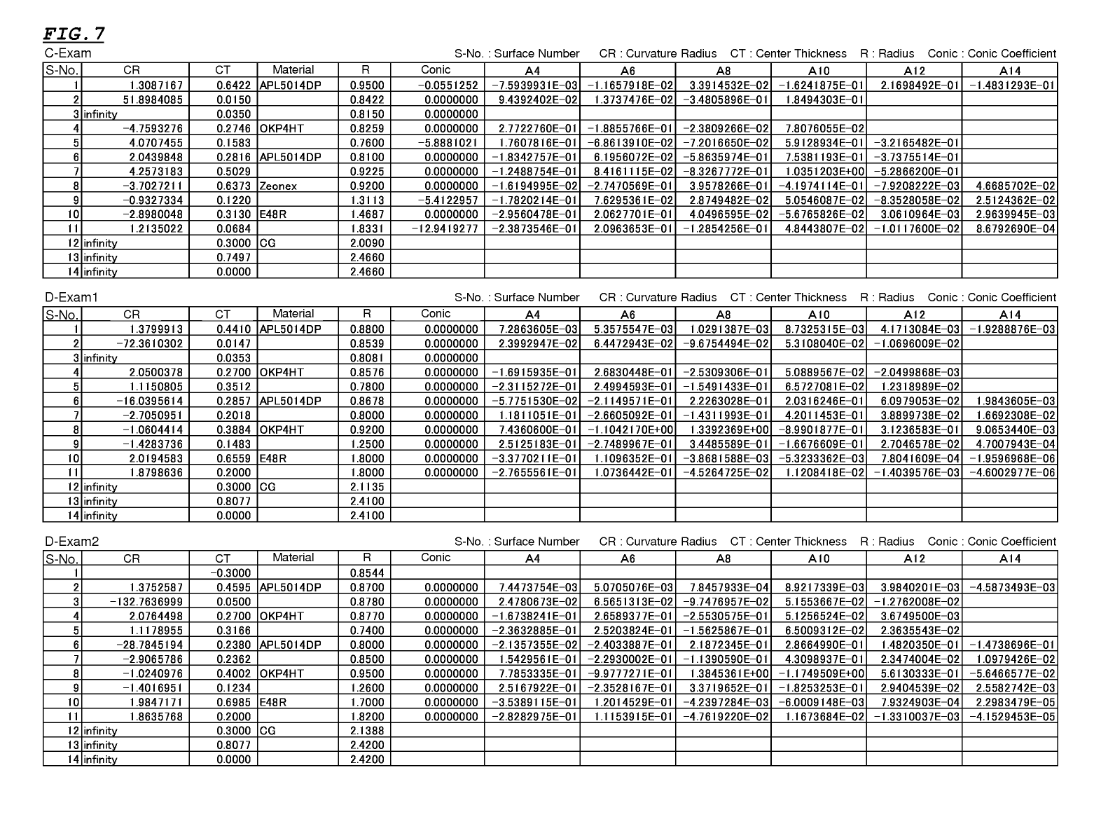

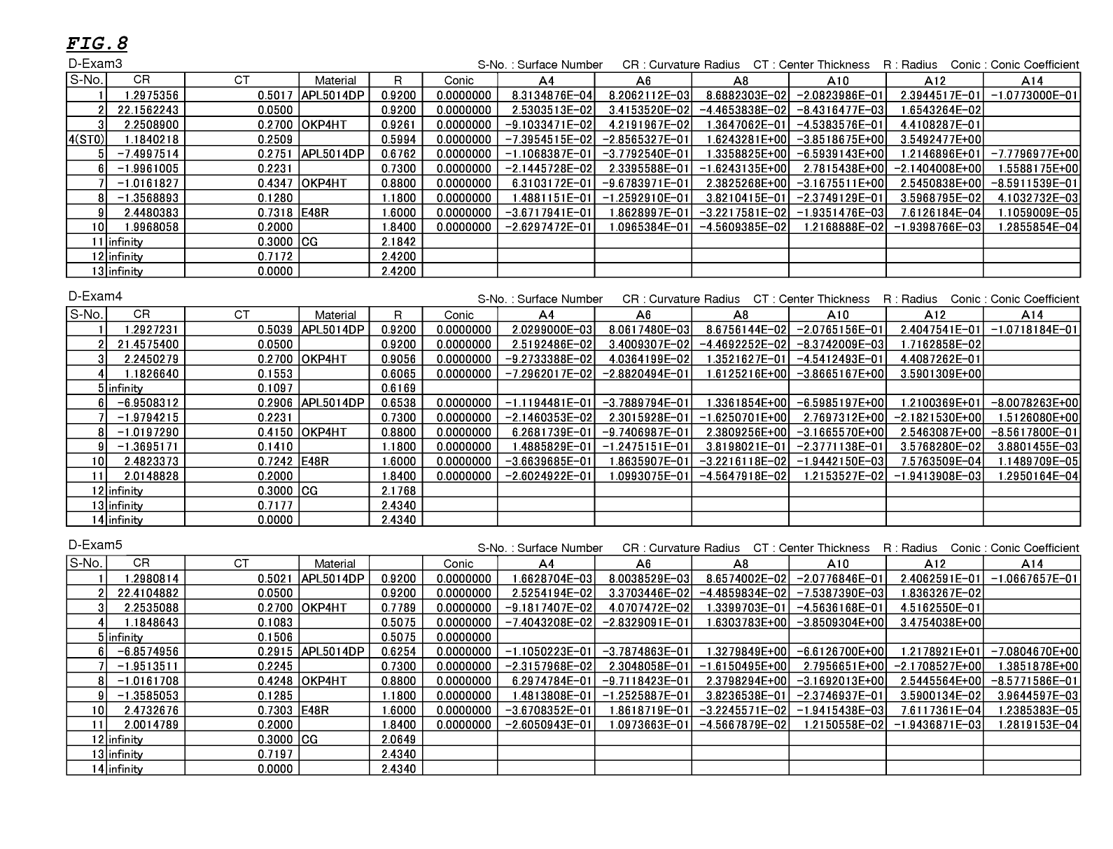

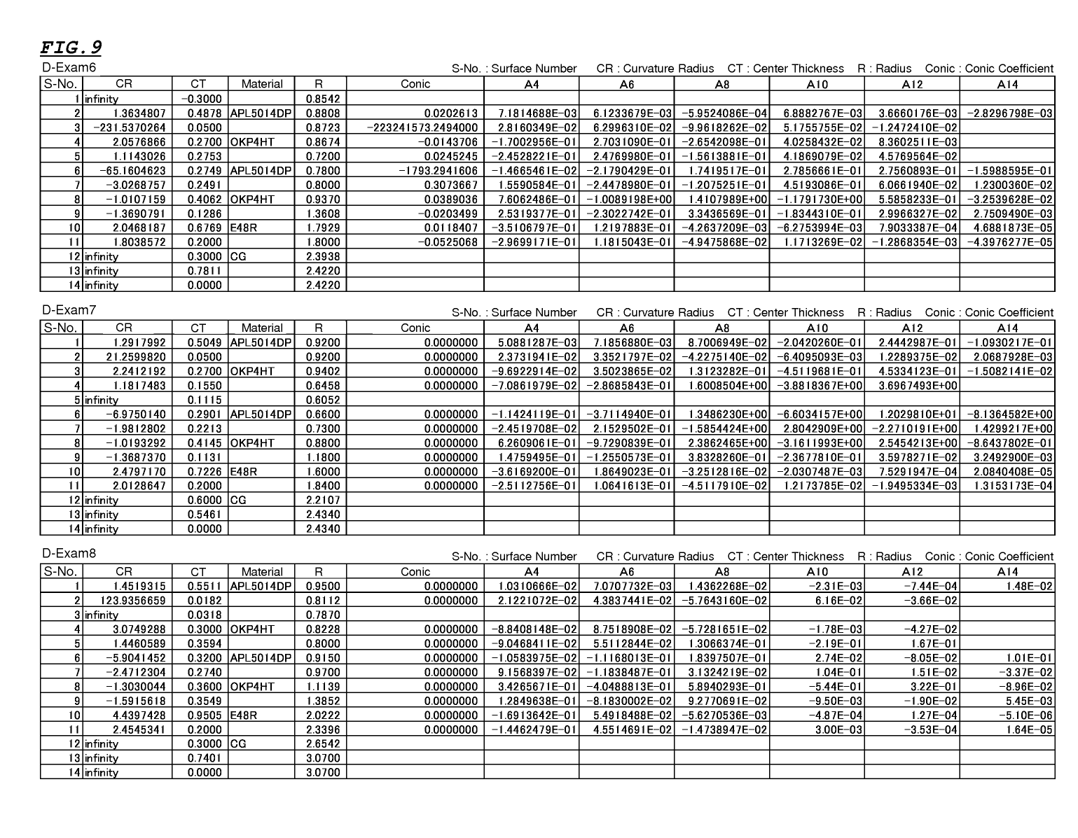

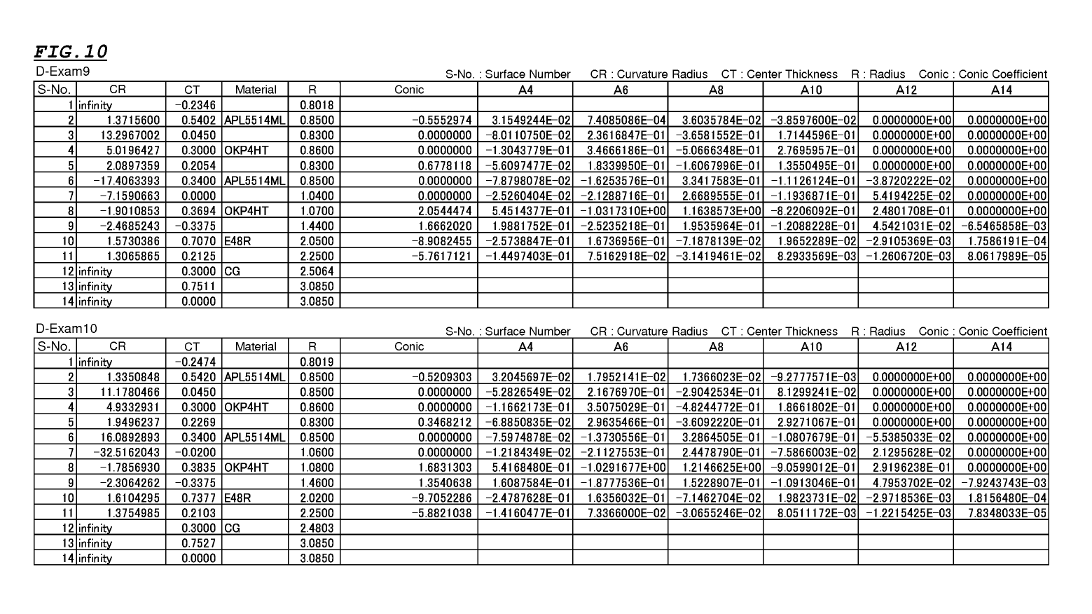

FIGS. 7 to 10 are diagrams showing design values in comparative example and in design examples 1 to 10.

Referring to FIGS. 7 to 10, “surface number” indicates the ordinal number of a surface of each of the optical components in the order from the object side. In comparative example, the surface numbers 1 and 2 indicate the lens surfaces of the lens element closest to the object side, the surface number 3 indicates the aperture stop, the surface numbers 4 to 11 indicate the lens surfaces of the second to fifth lens elements from the object side, the surface numbers 12 and 13 indicate the incident surface and the output surface of the cover glass, and the surface number 14 indicates the image plane. Further, in design example 1, the surface numbers 1 and 2 indicate the lens surfaces of the first lens element L1, the surface number 3 indicates the aperture stop, the surface numbers 4 to 11 indicate the lens surfaces of the second to fifth lens elements L2 to L5, the surface numbers 12 and 13 indicate the incident surface and the output surface of the cover glass, and the surface number 14 indicates the image plane. Likewise, in each of design examples 2 to 7, the surface numbers are correlated to the respective lens elements and to the aperture stop depending on the position of the aperture stop.

Further, referring to FIGS. 7 to 10, “curvature radius” indicates a curvature radius of a surface corresponding to each of the surface numbers, and “center thickness” indicates a distance from the surface corresponding to a certain surface number to the surface corresponding to the surface number following the certain surface number. “Material” indicates a material of the lens element corresponding to a certain surface number. The refractive index and the Abbe number of each of the materials are as shown below.

TABLE 1

| | Refractive index | Abbe number |
|---|---|---|
| APL5014DP | 1.5442 | 56.1 |
| OKP4HT | 1.6323 | 23.4 |
| E48R | 1.5315 | 55.7 |
| CG | 1.5163 | 64.1 |
| Zeonex | 1.5693 | 53.2 |

Further, referring to FIGS. 7 to 10, “radius” indicates a radius of each of the lens elements or a radius of an opening of the aperture stop, and “A4” to “A14” indicate aspherical coefficients of each of the lens elements.

The following is the expression representing the aspherical shape of each of the lens elements.

$$z = \frac{{cr}^{2}}{1 + \sqrt{1 - ( 1 + k ) {c}^{2} {r}^{2}}} + A 4 {r}^{4} + A 6 {r}^{6} + A 8 {r}^{8} + A 10 {r}^{10} + A 12 {r}^{12} + A 14 {r}^{14}$$

where z denotes a distance in the optical axis direction, assuming that a vertex of a surface is the point of origin, r denotes a distance in a direction perpendicular to the optical axis, c denotes a curvature, and k denotes a conic coefficient.

### <Parameter Values in Comparative Example and Design Examples>

Configuring the imaging lens 10 according to the aforementioned design values yields the parameter values shown in each of the columns in FIG. 5 regarding comparative example and design examples 1 to 10. In design examples 5, and 8 to 10, the F-number (FNO) is 2.4, and in design examples other than the above and in comparative example, the F-number (FNO) is 2.

Comparing between the table shown in FIG. 5, and the aforementioned conditional expressions (6) to (9), in comparative example and in design examples 1 to 10, the F-number (FNO) satisfies the conditional expression (6), and a fast imaging lens is implemented. Further, in comparative example and in design examples 1 to 10, (TTL−fB)/D satisfies the conditional expression (7), and a low-height imaging lens 10 is implemented. Further, in comparative example and in design examples 1 to 10, FB/FNO satisfies the conditional expression (8), and the flange back length is a length taking into consideration of an influence of dust on a captured image.

In comparative example, however, FB is smaller than 1.0, and the conditional expression (9) is not satisfied. As a result, in comparative example, it is difficult to secure the clearances d1 and d4, and the thickness d3 shown in FIG. 6D, and the drawbacks such as collision between the fifth lens element L5 and the cover glass cg, and obstruction involved in providing wire bonding should be considered. In contrast, in all design examples 1 to 10, FB is not smaller than 1.0, and the conditional expression (9) is satisfied. Thus, according to design examples 1 to 10, it is possible to design an imaging lens capable of avoiding the drawbacks such as collision between the fifth lens element L5 and the cover glass cg, and obstruction involved in providing wire bonding.

Referring to FIG. 5, it is clear that, as compared with comparative example, in design examples 1 to 10, CRA is small, and the incident angle of light ray with respect to the image plane is small. In particular, in design examples 2, 6, 9, and 10, in which the aperture stop AP is disposed on the object side of the first lens element L1, and in design examples 1 and 8, in which the aperture stop AP is disposed between the first lens element L1 and the second lens element L2, CRA is not larger than 30.0 degrees, and the incident angle of light ray with respect to the image plane is effectively suppressed. As CRA decreases, it is easy to allow a light ray to enter the pixels of the imaging sensor element. This is advantageous in enhancing the imaging performance. Accordingly, it can be concluded that disposing the aperture stop AP on the object side of the first lens element L1, or between the first lens element L1 and the second lens element L2 is advantageous in enhancing the imaging performance.

Further, in design example 9, the negative power of the fourth lens element is made large, and instead, the negative power of the focal length of the second lens element is made small. This makes it possible to shorten the air interval between the peripheral portions of the second lens element and the third lens element, as compared with design example 8, and makes it possible to reduce TTL. As a result of intensive study, it has been found that it is desirable to make the absolute value of the focal length of the fourth lens element smaller than the focal length of the third lens element. Satisfying the condition: f3>|f4| makes it possible to make the overall TTL/D (image size) small, and to alleviate the requirements on manufacturing tolerances substantially equivalently.

Further, in design example 10, the third lens element is a biconvex lens element. Configuring design example 10 as described above makes it possible to increase the air interval between the peripheral portions of the second lens element and the third lens element. This is advantageous in miniaturization. Further, constituting the third lens element of a biconvex lens element makes it possible to distribute the positive power to the front-side lens surface and the rear-side lens surface. This is advantageous in alleviating the requirements on manufacturing tolerances with respect to optical axis misalignment between the lens surfaces.

### Optical Characteristics

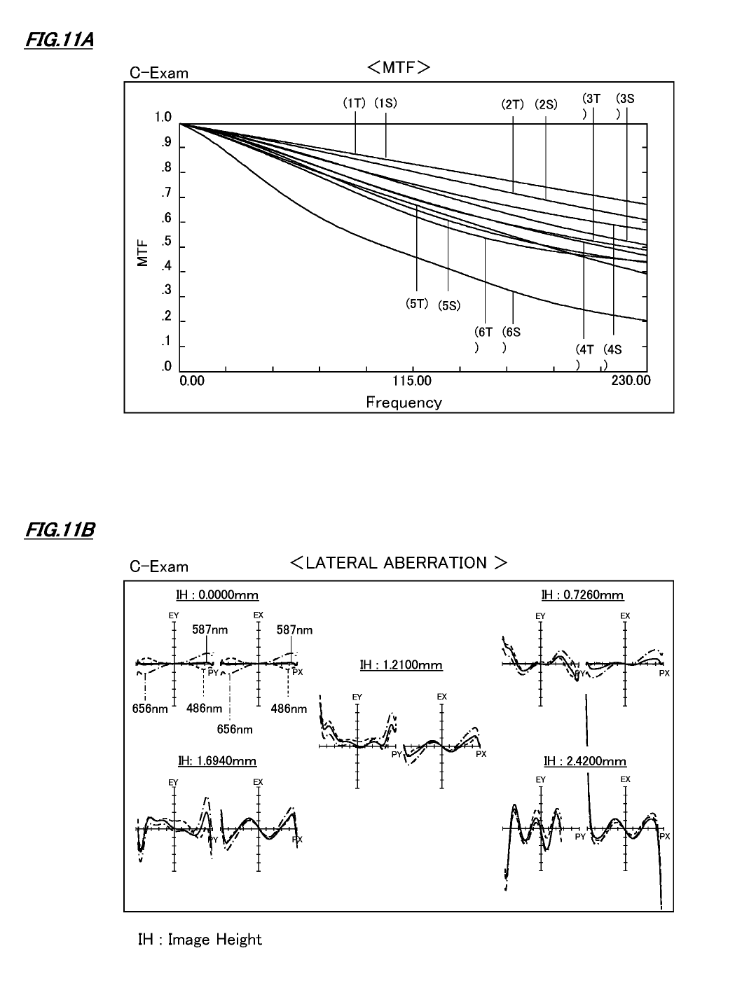

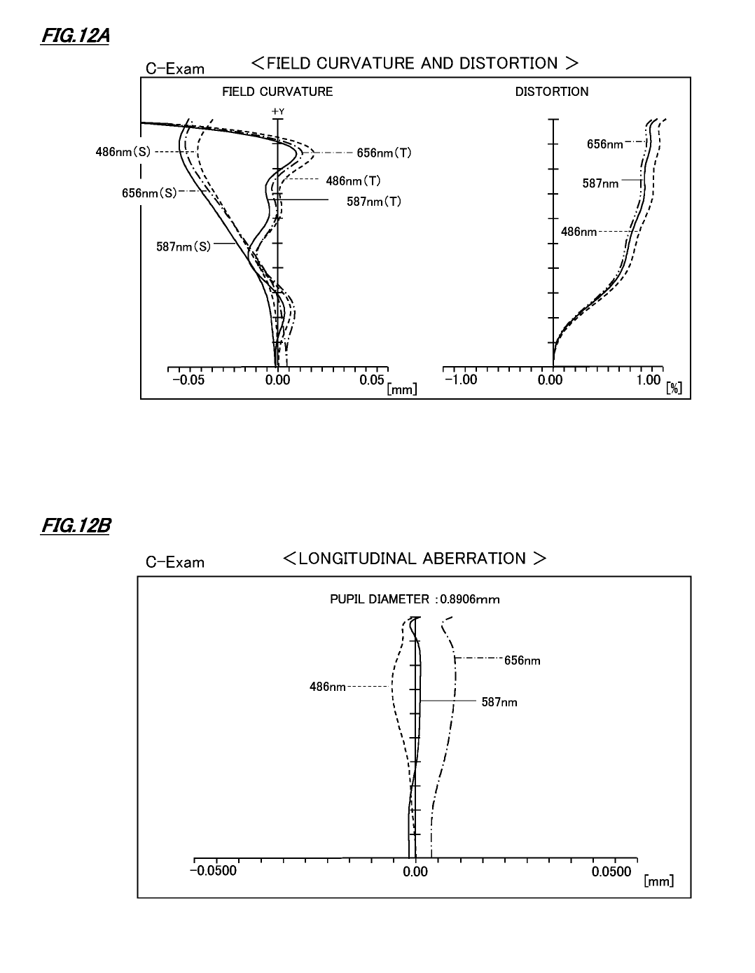

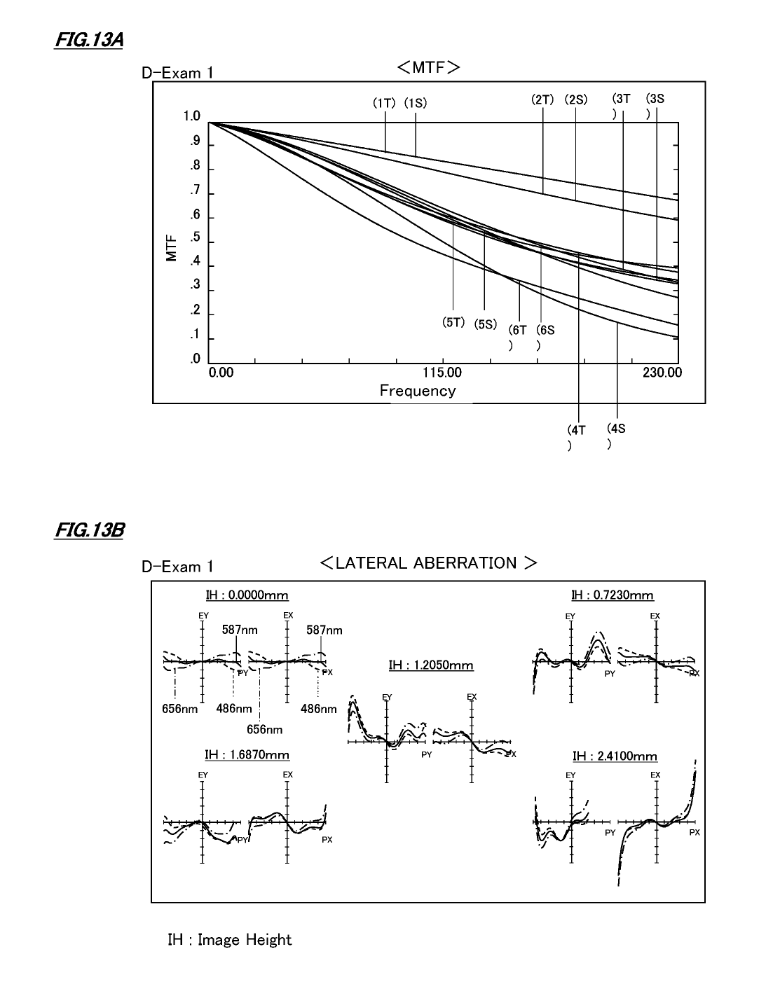

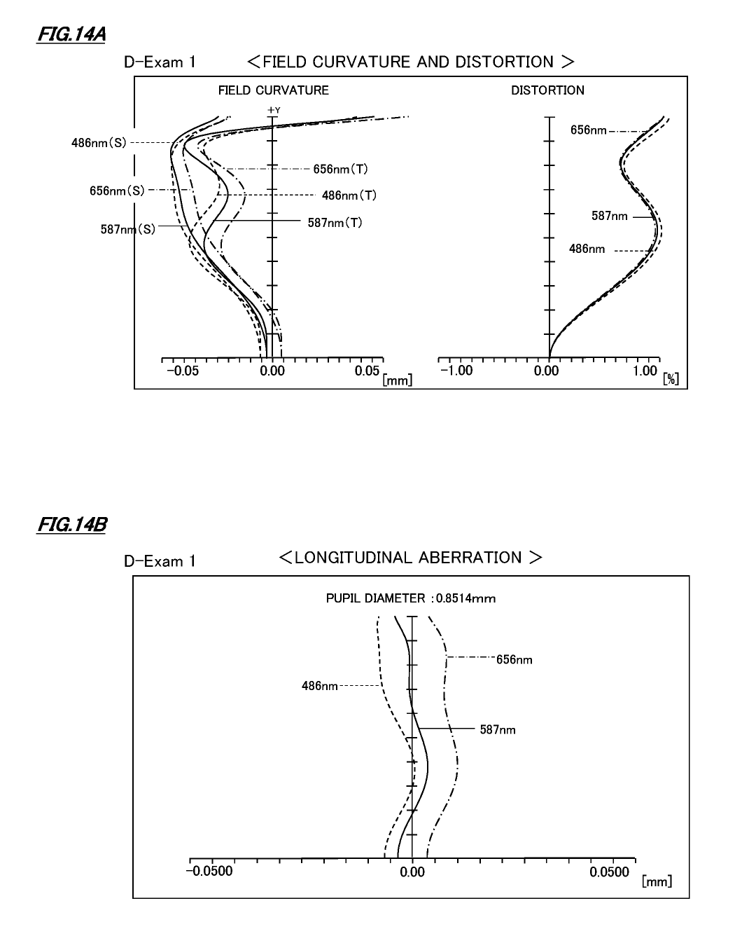

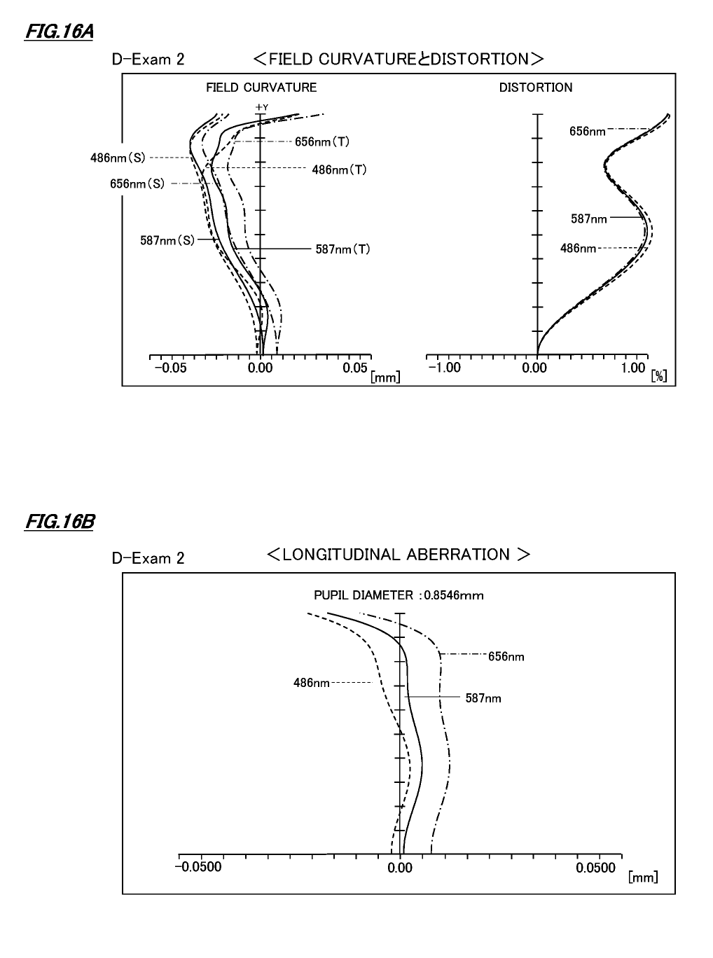

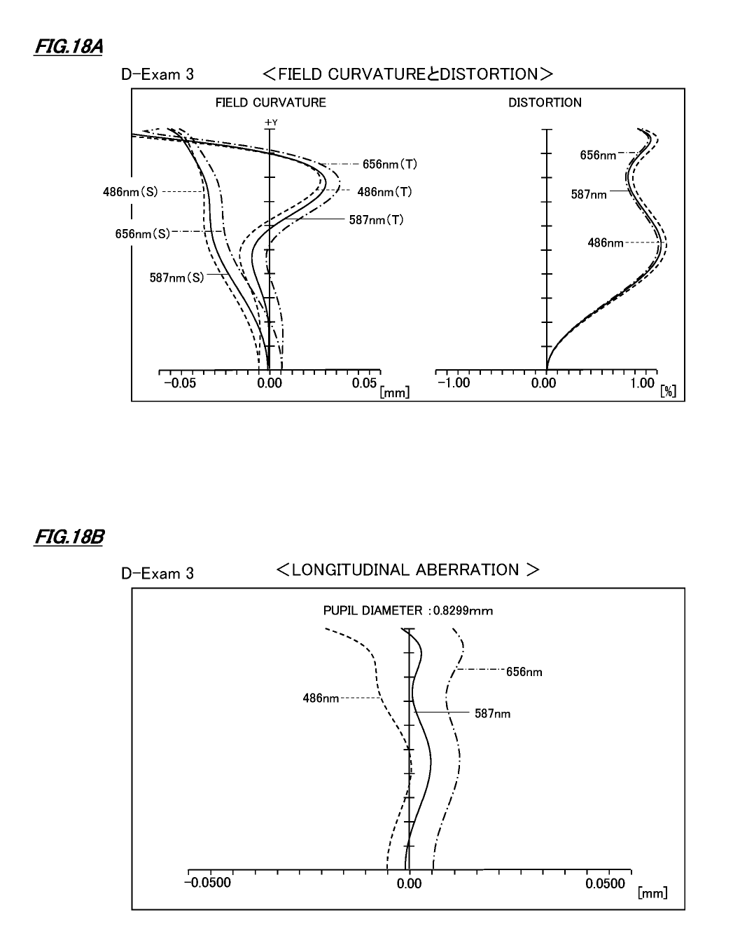

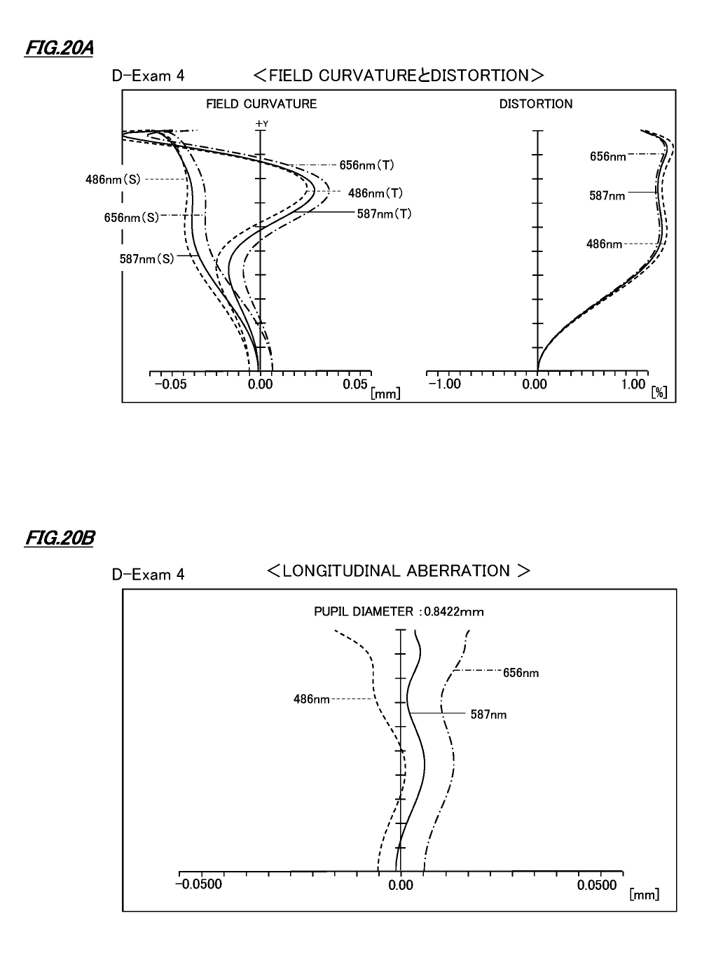

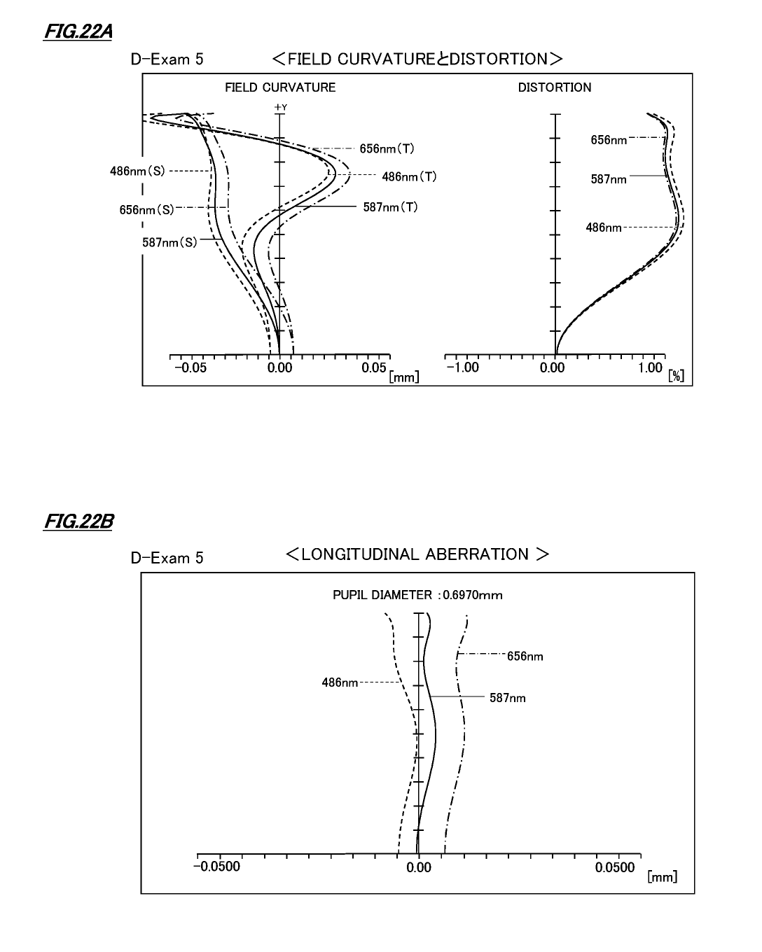

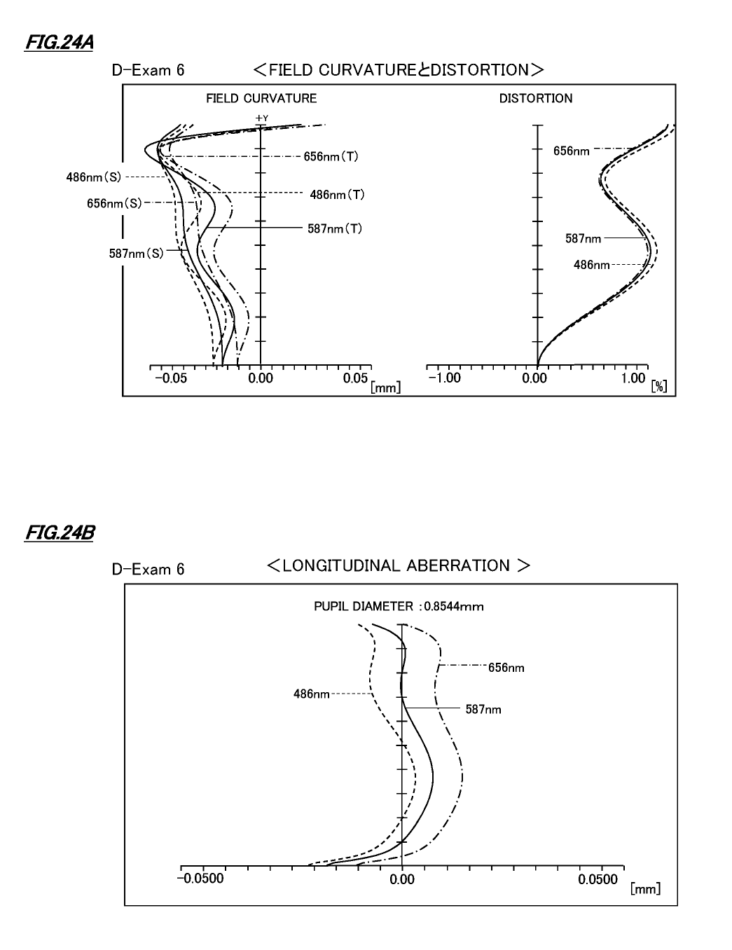

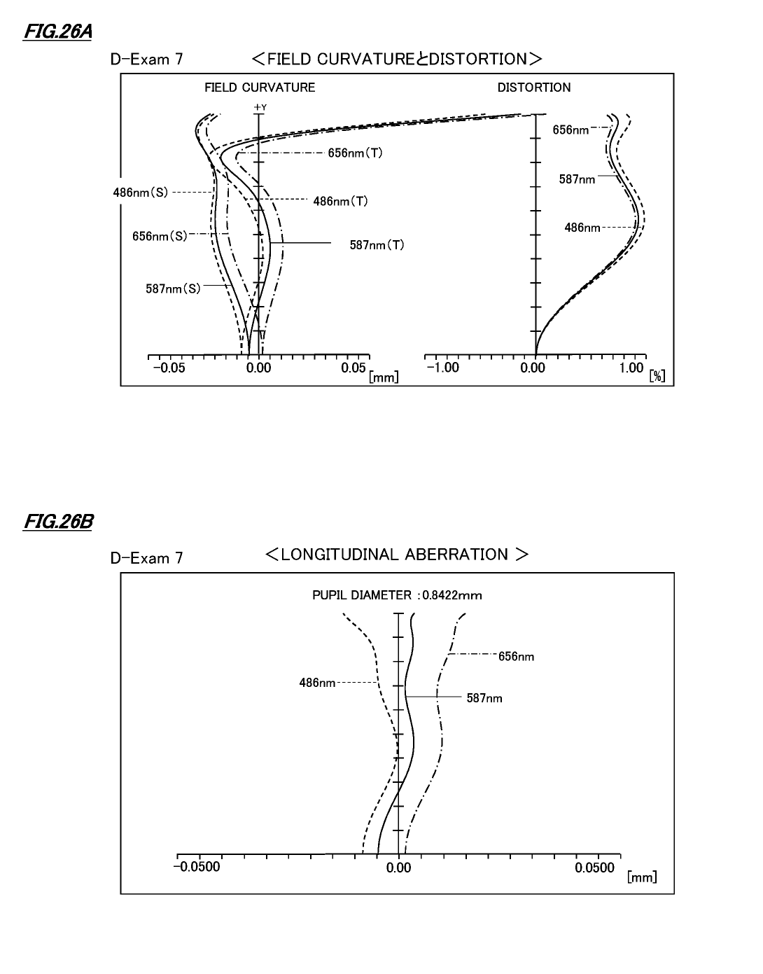

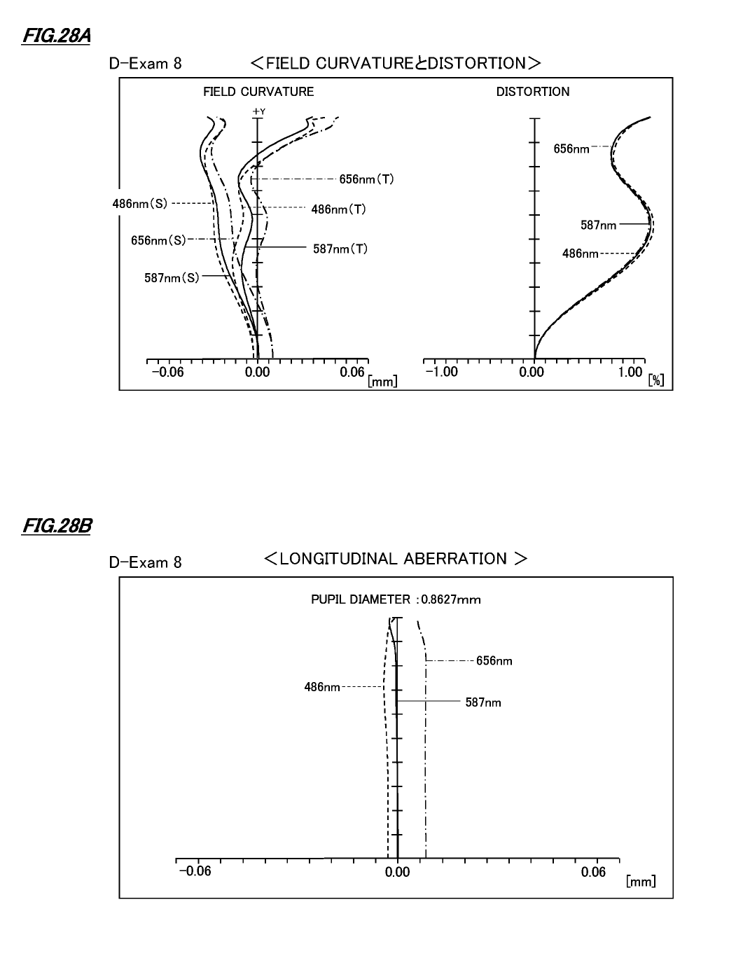

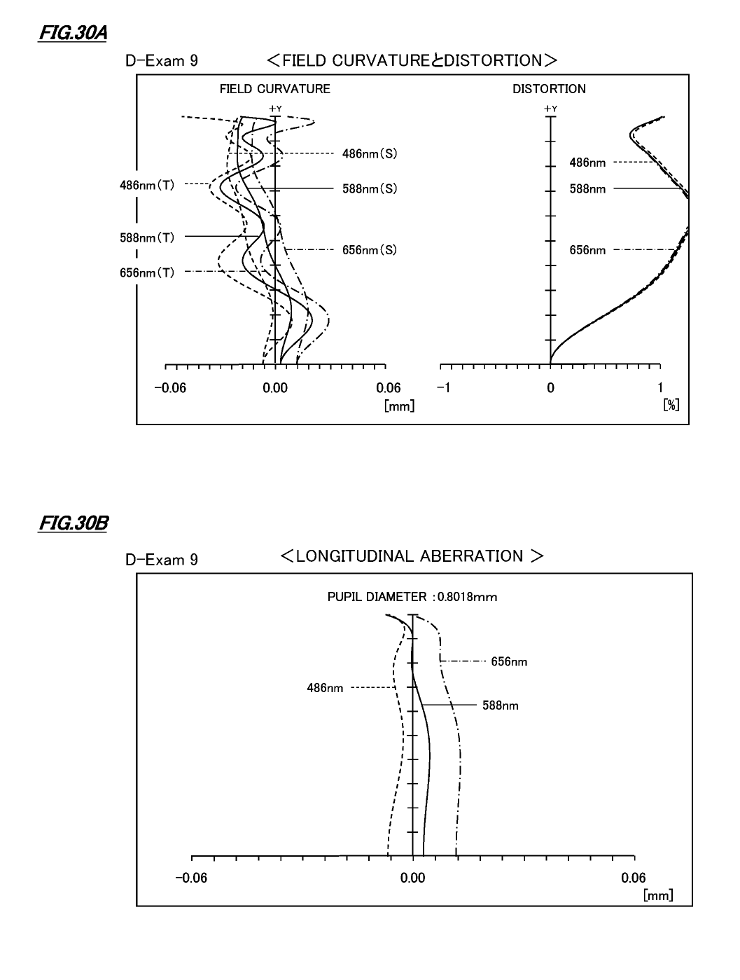

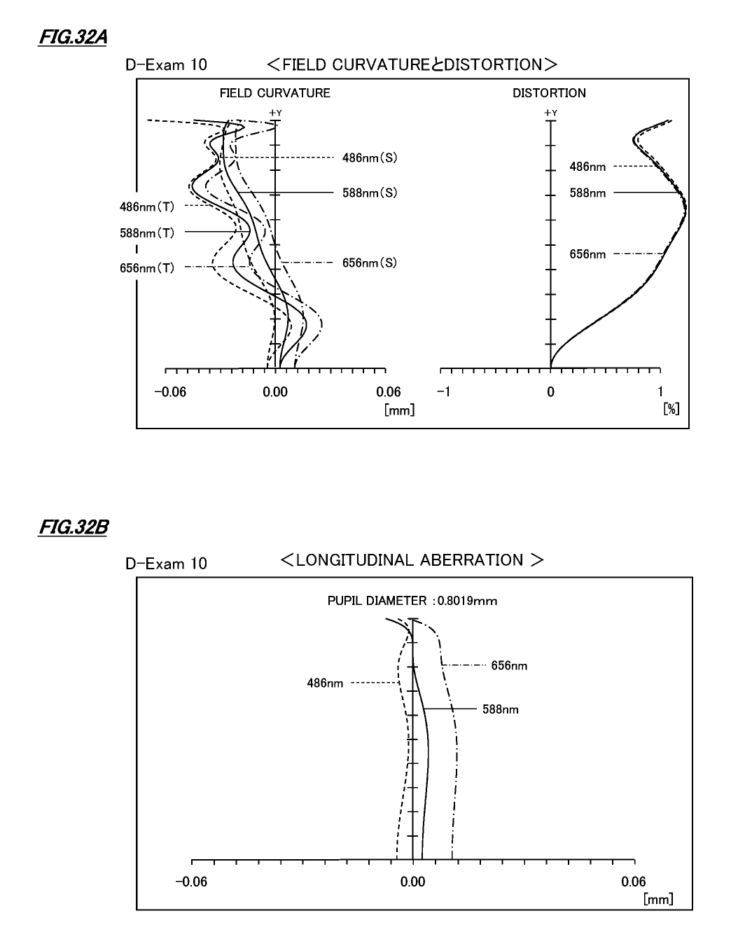

FIGS. 11A to 32B are diagrams showing the optical characteristics of the imaging lenses in comparative example and in design examples 1 to 10. FIGS. 11A, 11B, 12A, and 12B show MTF, lateral aberration, field curvature, distortion, and longitudinal aberration of the imaging lens in comparative example. Further, FIGS. 13A to 32B respectively show MTF, lateral aberration, field curvature, distortion, and longitudinal aberration of the imaging lenses in design examples 1 to 10.

FIGS. 11A, 13A, 15A, 17A, 19A, 21A, 23A, 25A, 27A, 29A, and 31A respectively show the imaging characteristics (MTF) of the imaging lenses in comparative example and in design examples 1 to 10. In these drawings, (1T, 1S) respectively indicate the MTF characteristics on tangential and sagittal planes at the diffraction limit, and (2T, 2S) respectively indicate the MTF characteristics on tangential and sagittal planes at the middle position (image height=0 mm) of the image size. Further, in these drawings, (3T, 3S), (4T, 4S), (5T, 5S), and (6T, 6S) respectively indicate the MTF characteristics on tangential and sagittal planes obtained at the positions away from the middle of the image size by a predetermined ratio with respect to the range from the middle to the boundary of the image size.

Specifically, (3T, 3S), (4T, 4S), (5T, 5S), and (6T, 6S) respectively indicate the MTF characteristics on tangential and sagittal planes at the positions away from the middle of the image size by the distance corresponding to 30%, 50%, 70%, and 100% of the range (image height/2) from the middle to the boundary of the image size.

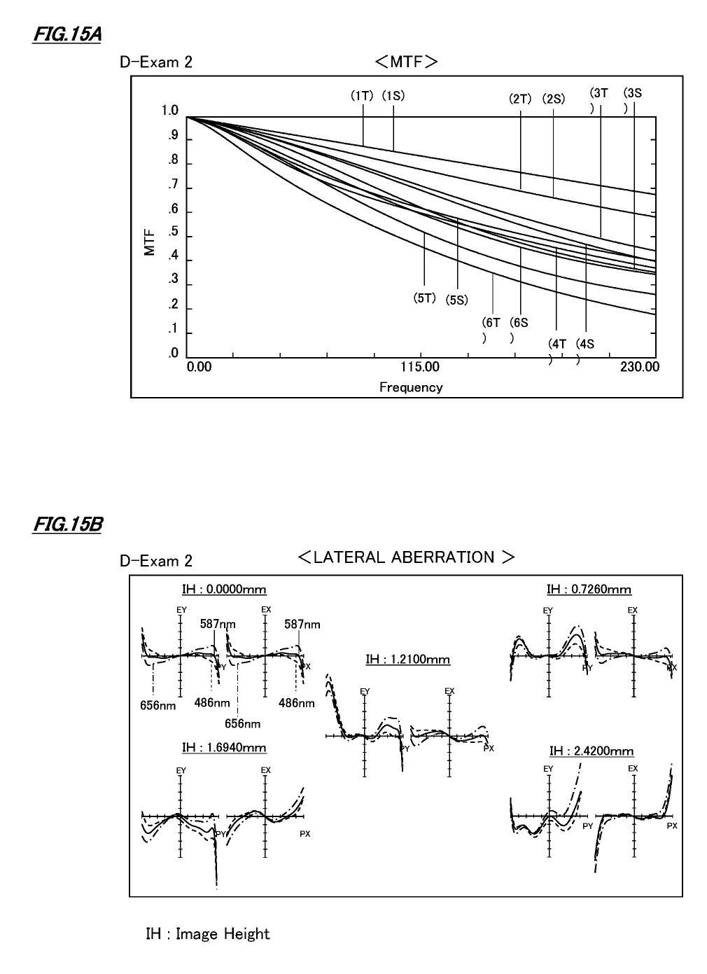

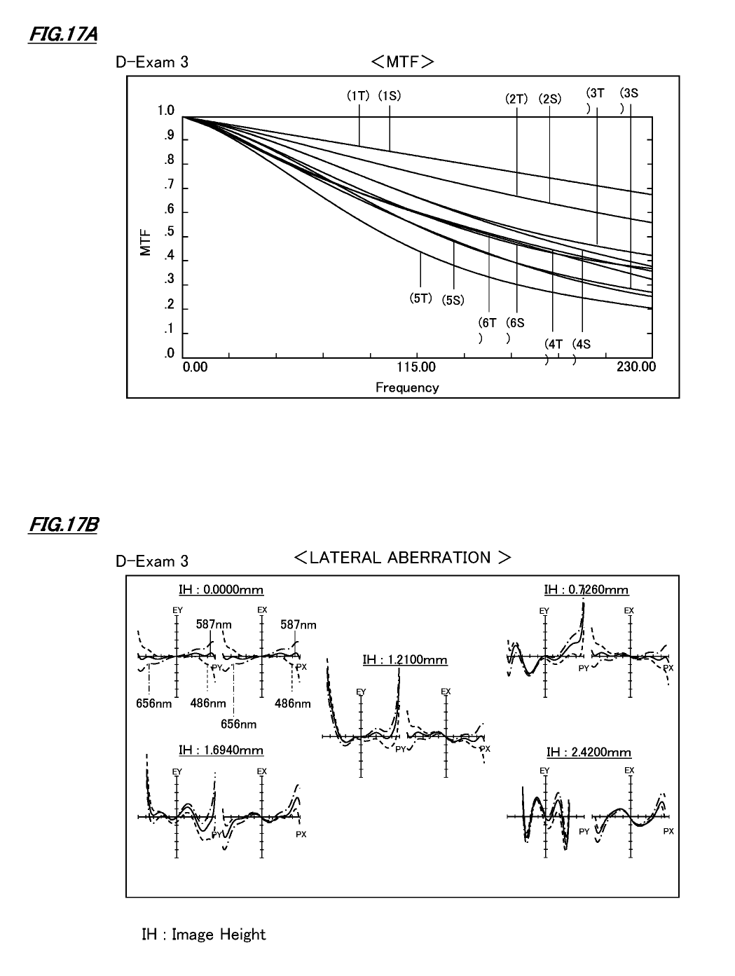

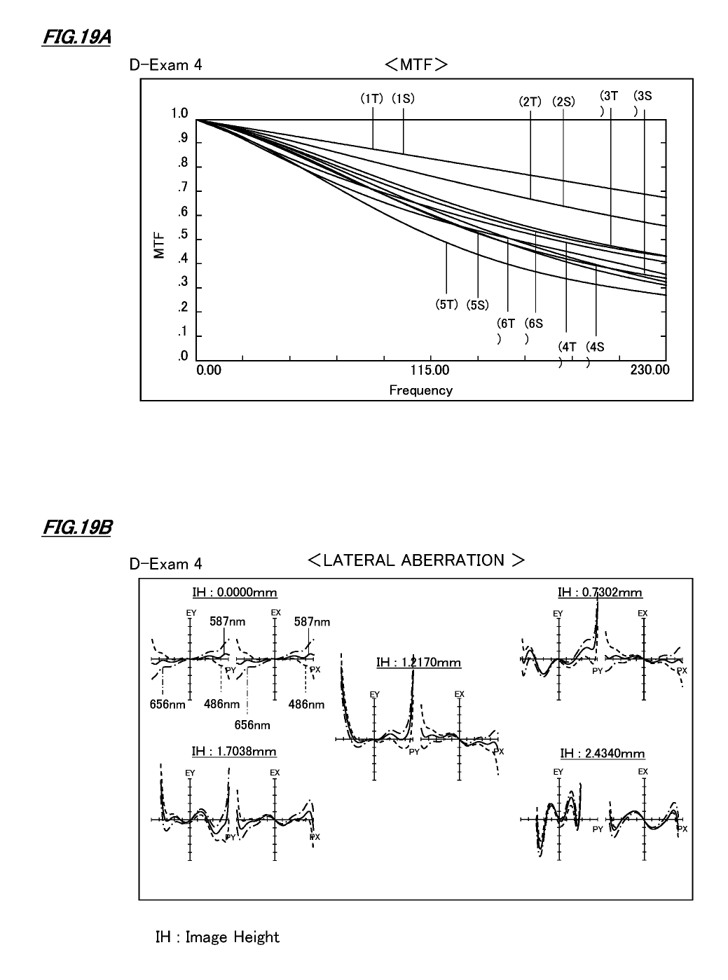

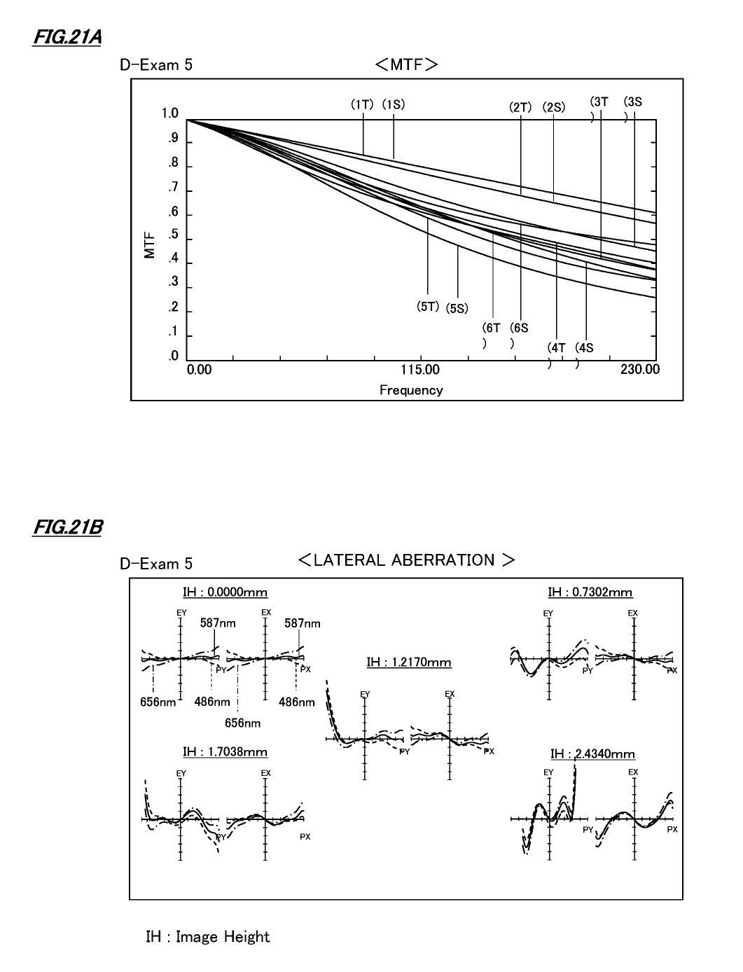

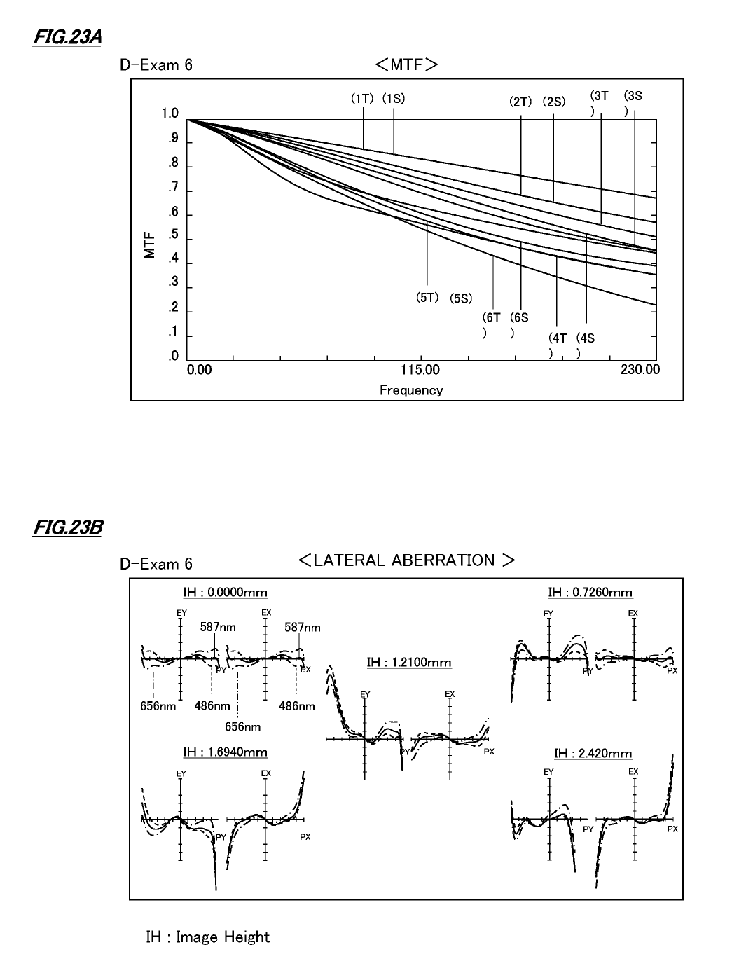

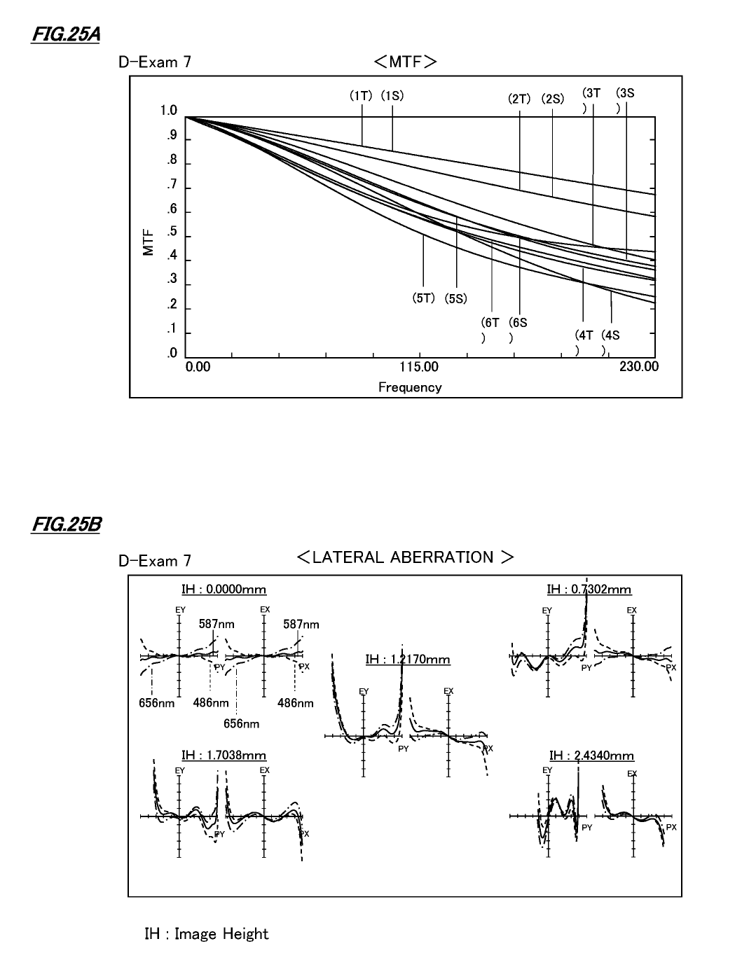

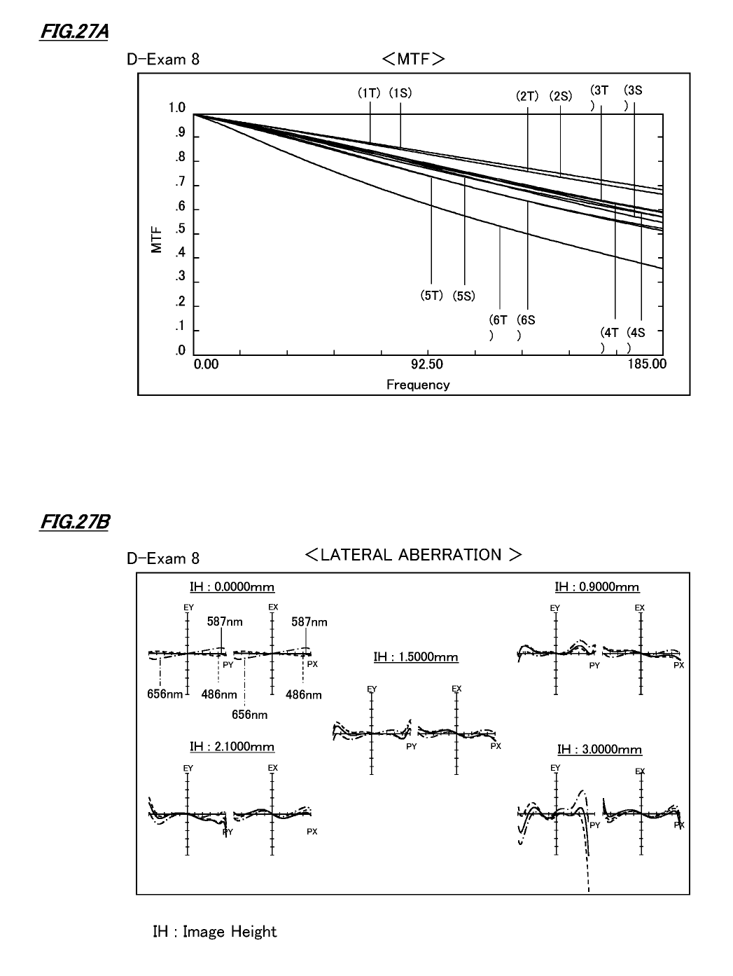

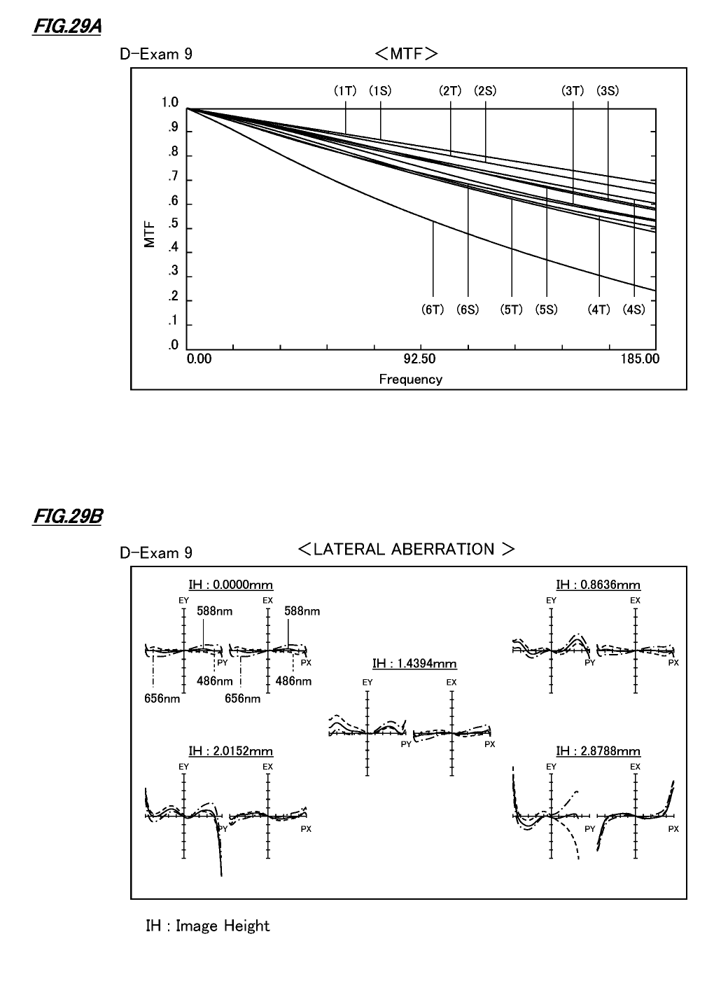

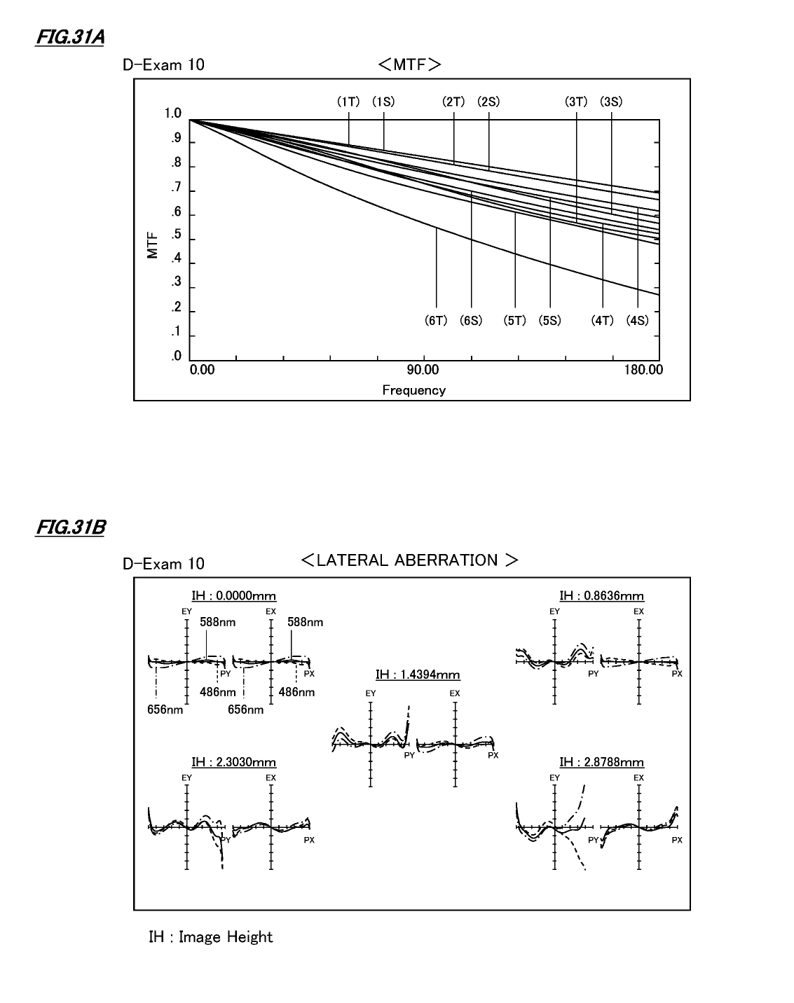

For instance, in comparative example, design example 2, design example 3, and design example 6, the image height is 4.840 mm (see FIG. 5). Accordingly, in FIG. 11A (comparative example), FIG. 15A (design example 2), FIG. 17A (design example 3), and FIG. 23A (design example 6), the curves of (3T, 3S), (4T, 4S), (5T, 5S), and (6T, 6S) respectively show the MTF characteristics obtained at the positions away from the middle of the image size by 0.7260 mm, 1.2100 mm, 1.6940 mm, and 2.4200 mm. Further, in design example 1, the image height is 4.820 mm (see FIG. 5). Accordingly, in FIG. 13A (design example 1), the curves of (3T, 3S), (4T, 4S), (5T, 5S), and (6T, 6S) respectively show the MTF characteristics obtained at the positions away from the middle of the image size by 0.7230 mm, 1.2050 mm, 1.6870 mm, and 2.4100 mm. Further, in design example 4, design example 5, and design example 7, the image height is 4.868 mm (see FIG. 5). Accordingly, in FIG. 19A (design example 4), FIG. 21A (design example 5), and FIG. 25A (design example 7), the curves of (3T, 3S), (4T, 4S), (5T, 5S), and (6T, 6S) respectively show the MTF characteristics obtained at the positions away from the middle of the image size by 0.7302 mm, 1.2170 mm, 1.7038 mm, and 2.4340 mm. Further, in design example 8, the image height is 6.000 mm (see FIG. 5). Accordingly, in FIG. 27A (design example 8), the curves of (3T, 3S), (4T, 4S), (5T, 5S), and (6T, 6S) respectively show the MTF characteristics obtained at the positions away from the middle of the image size by 0.9000 mm, 1.5000 mm, 2.1000 mm, and 3.0000 mm. Further, in design example 9 and design example 10, the image height is 5.712 mm (see FIG. 5). Accordingly, in FIG. 29A (design example 9) and FIG. 31A (design example 10), the curves of (3T, 3S), (4T, 4S), (5T, 5S), and (6T, 6S) respectively show the MTF characteristics obtained at the positions away from the middle of the image size by 0.8568 mm, 1.4280 mm, 1.9992 mm, and 2.856 mm.

FIGS. 11B, 13B, 15B, 17B, 19B, 21B, 23B, 25B, 27B, 29B, and 31B respectively show the lateral aberrations of the imaging lenses in comparative example and in design examples 1 to 10. These drawings show the lateral aberrations at the respective image heights.

FIGS. 12A, 14A, 16A, 18A, 20A, 22A, 24A, 26A, 28A, 30A, and 32A respectively show the field curvatures and the distortions in comparative example and in design examples 1 to 10. These drawings show the field curvatures and the distortions with respect to light of wavelengths 486 nm, 587 nm, and 656 nm. The symbols (T) and (S) attached to each of the wavelengths respectively indicate the field curvatures on tangential and sagittal planes.

FIGS. 12B, 14B, 16B, 18B, 20B, 22B, 24B, 26B, 28B, 30B, and 32B respectively show the longitudinal aberrations in comparative example and in design examples 1 to 10. These drawings show the longitudinal aberrations with respect to light of wavelengths 486 nm, 587 nm and 656 nm.

Referring to FIGS. 11A to 32B, in comparative example and in design examples 1 to 10, preferable optical characteristics are obtained with respect to MTF, lateral aberration, field curvature, distortion, and longitudinal aberration. Specifically, in comparative example and in design examples 1 to 10, the parameter values shown in FIG. 5 are obtained, while securing preferable optical characteristics. Accordingly, in design examples 1 to 10, a fast and low-height imaging lens with a long flange back length is implemented, while securing preferable optical characteristics.

### Manufacturing Tolerances

Generally, in a fast imaging lens with small F-number, the requirements on manufacturing tolerances with respect to optical axis misalignment of a lens are high. Optical axis misalignment of a lens element constituting an imaging lens may deteriorate the imaging performance (MTF). In view of the above, it is desirable to suppress lowering of the imaging performance resulting from manufacturing tolerances as much as possible in order to maintain the imaging performance of the imaging lens as designed.

The following is a description about the level of requirements on manufacturing tolerances in comparative example and in design examples 1 to 10.

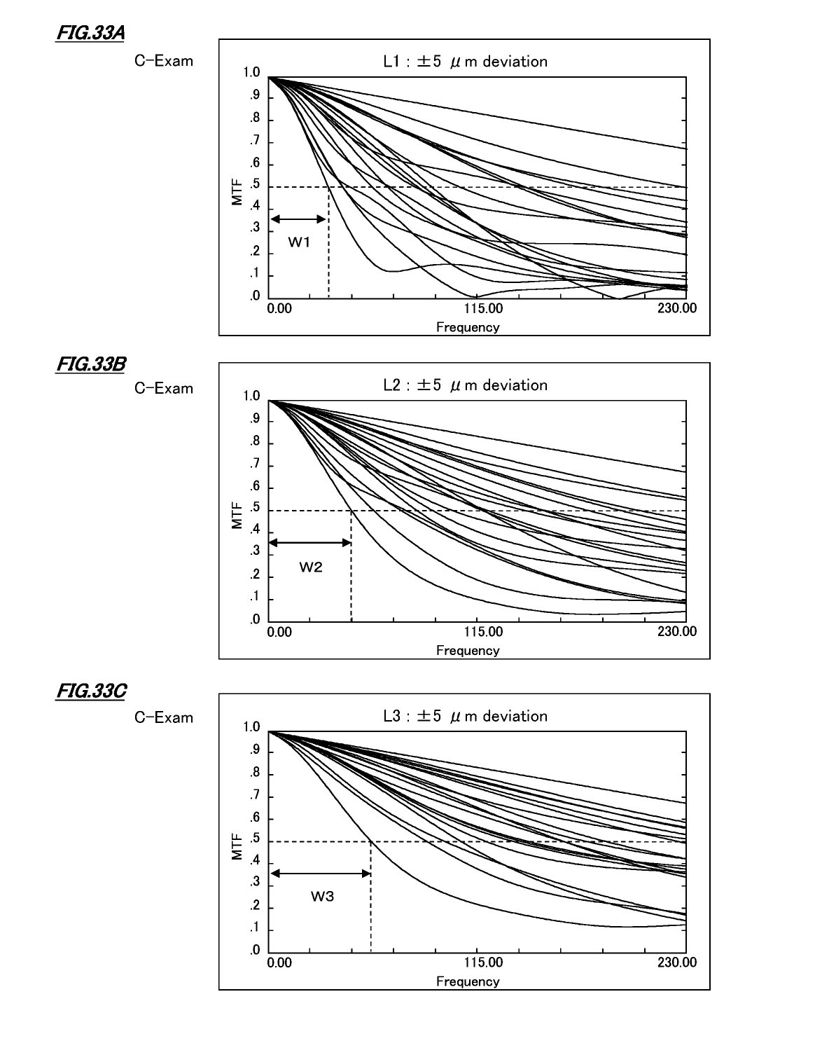

FIGS. 33A to 54B are diagrams showing degrees of deterioration (simulation results) of MTF, in the case where positional deviation occurs in one of the first to fifth lens elements L1 to L5 in comparative example and in design examples 1 to 10. In this example, MTF in the case where the optical axis of one of the first to fifth lens elements L1 to L5 is deviated from the optical axis of the imaging lens by 5 μm is obtained by simulation.

FIGS. 11A, 13A, 15A, 17A, 19A, 21A, 23A, 25A, 27A, 29A, and 31A respectively show the MTF characteristics on tangential and sagittal planes at the positions away from the middle of the image size in a certain direction by the distance corresponding to 30%, 50%, 70%, and 100% of the range from the middle to the boundary of the image size. FIGS. 33A to 54B show the MTF characteristics on tangential and sagittal planes at the positions away from the middle of the image size in a certain direction and in a direction opposite to the certain direction by the distance corresponding to 30%, 50%, 70%, and 100% of the range from the middle to the boundary of the image size.

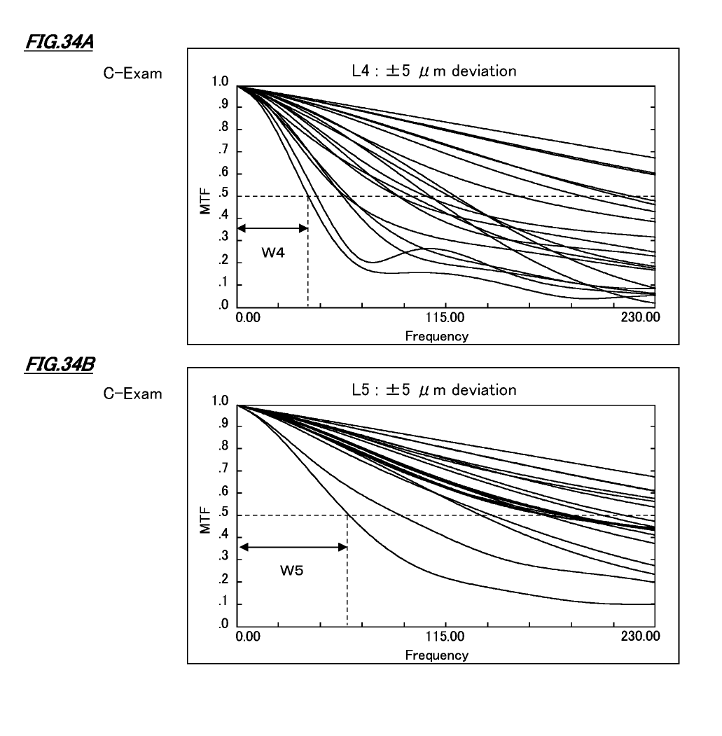

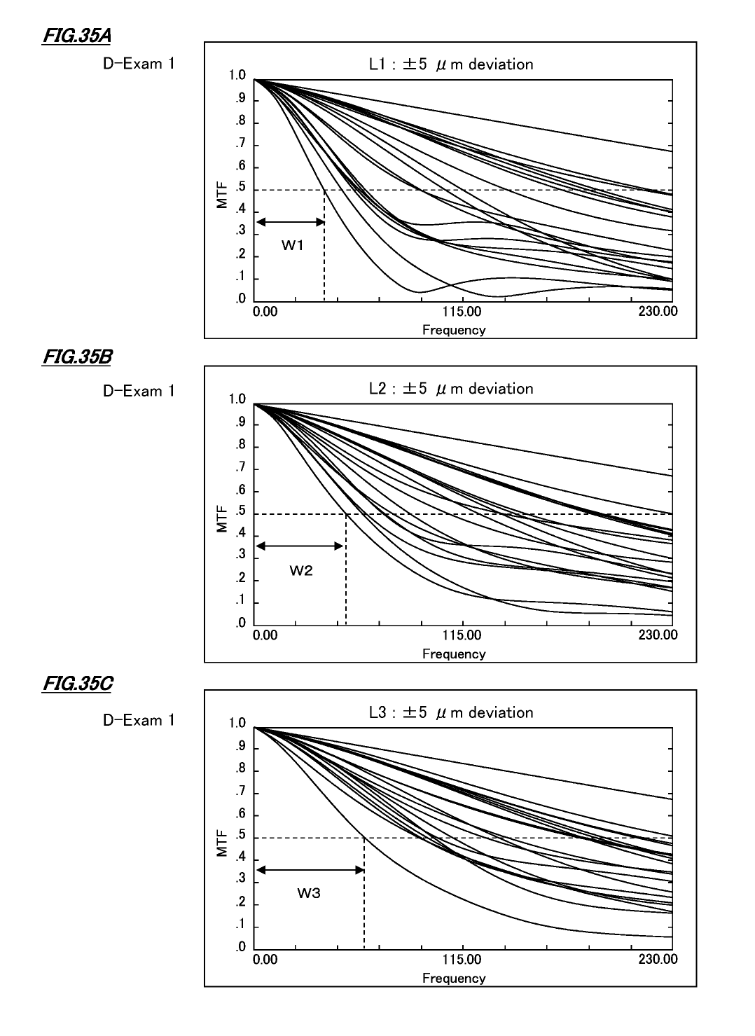

FIGS. 33A to 33C, and FIGS. 34A and 34B are diagrams showing degree of deterioration of MTF in comparative example. FIGS. 33A to 33C respectively show MTF, in the case where the optical axes of the first lens element L1, the second lens element L2, and the third lens element L3 are deviated from the optical axis of the imaging lens by ±5 μm. FIGS. 34A and 34B respectively show MTF, in the case where the optical axes of the fourth lens element L4 and the fifth lens element L5 are deviated from the optical axis of the imaging lens by ±5 μm. Likewise, FIGS. 35A to 54B show degrees of deterioration of MTF in design examples 1 to 10.

In each of the drawings, a degree of deterioration of MTF is evaluated, based on a frequency width (W1 to W5 in the drawings) when MTF is 0.5. As the frequency width is narrowed, the degree of deterioration of MTF resulting from optical axis misalignment tends to be remarkably large, and it is evaluated that the requirements on manufacturing tolerances are high. Generally, it is said that when MTF is lowered below 0.5, the image quality is affected. In view of the above, in this example, the degree of deterioration of MTF is evaluated, based on a frequency width when MTF is 0.5.

Firstly, referring to FIGS. 33A to 34B, in comparative example, in the case where optical axis misalignment occurs in the first lens element L1, the degree of deterioration of MTF is large, and the frequency width W1 is considerably narrow. Accordingly, it can be concluded that, in comparative example, the requirements on manufacturing tolerances with respect to the first lens element L1 are remarkably high. Further, in the case where optical axis misalignment occurs in the fourth lens element L4, the degree of deterioration of MTF is large, and the frequency width W2 is narrow. Accordingly, it can be concluded that, in comparative example, the requirements on manufacturing tolerances with respect to the fourth lens element L4 are also high. Further, in the case where optical axis misalignment occurs in the second lens element L2, the degree of deterioration of MTF is relatively large, and the frequency width W2 is narrow. Accordingly, it can be concluded that, in comparative example, the requirements on manufacturing tolerances with respect to the second lens element L2 are also relatively high.

As described above, it can be concluded that, in comparative example, the requirements on manufacturing tolerances with respect to the first lens element L1 are particularly high, and the requirements on manufacturing tolerances with respect to the fourth lens element L4 are also high. Further, the requirements on manufacturing tolerances with respect to the second lens element L2 are relatively high, and the overall requirements on manufacturing tolerances are high.

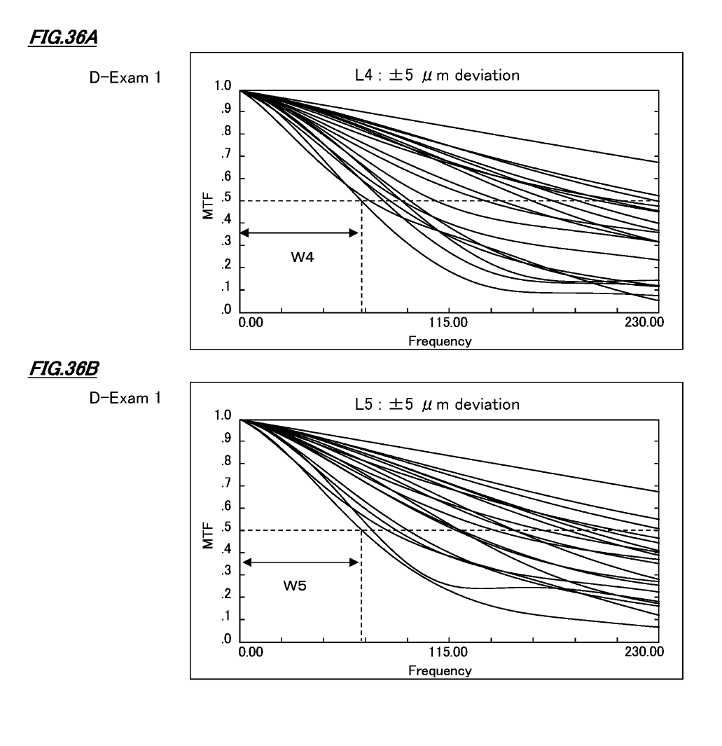

Next, referring to FIGS. 35A to 36B, in design example 1, in the case where optical axis misalignment occurs in the first lens element L1, MTF is deteriorated, and the frequency width W1 is narrow. However, the frequency width W1 in this case is wider than the frequency width W1 in comparative example. Accordingly, the requirements on manufacturing tolerances with respect to the first lens element L1 are low, as compared with the first lens element L1 in comparative example. Further, in design example 1, in the case where optical axis misalignment occurs in the second lens element L2, MTF is slightly deteriorated, and the frequency width W2 is slightly narrow. However, the frequency width W2 in this case is wider than the frequency width W2 in comparative example. Accordingly, the requirements on manufacturing tolerances with respect to the second lens element L2 is low, as compared with the second lens element L2 in comparative example.

Further, in design example 1, the degree of deterioration of MTF in the case where optical axis misalignment occurs in the fourth lens element L4 is considerably low, as compared with a case, in which optical axis misalignment occurs in the fourth lens element L4 in comparative example. The frequency width W4 in design example 1 is considerably wide, as compared with the frequency width W4 in comparative example. Accordingly, the requirements on manufacturing tolerances with respect to the fourth lens element L4 are considerably low, as compared with comparative example. In addition to the above, in design example 1, the frequency widths W3 and W5 with respect to the third lens elements L3 and the fifth lens element L5 are wide, and it can be concluded that the overall requirements on manufacturing tolerances are low.

As described above, in design example 1, the overall requirements on manufacturing tolerances are considerably low, as compared with comparative example, although the requirements on manufacturing tolerances with respect to the first lens element L1 are slightly high.

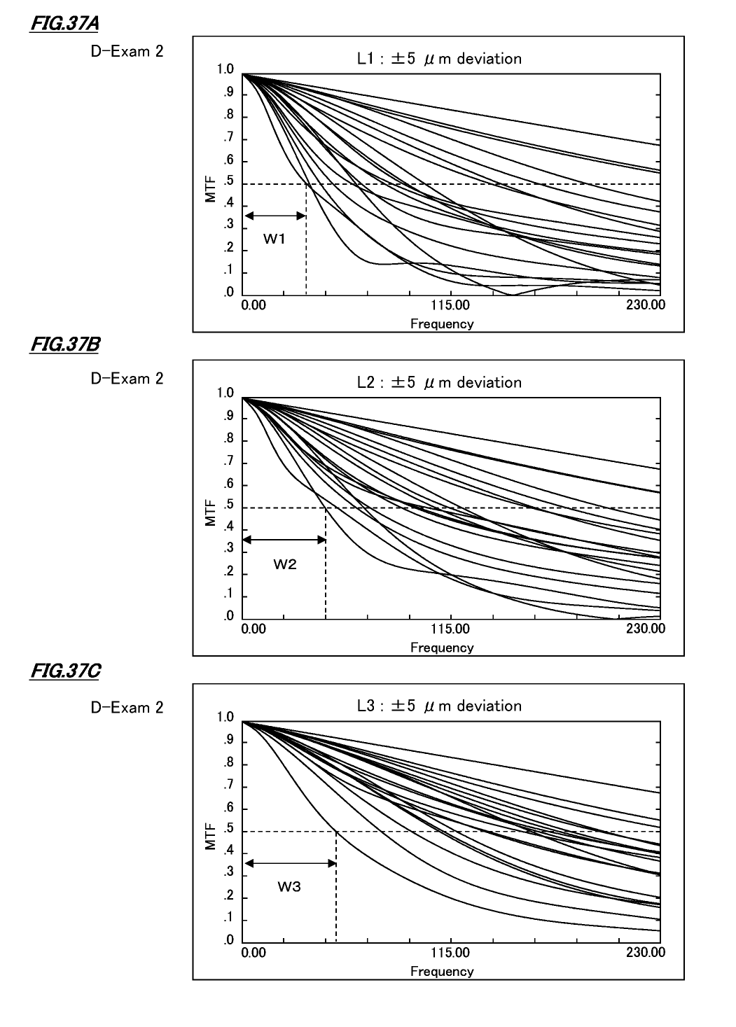

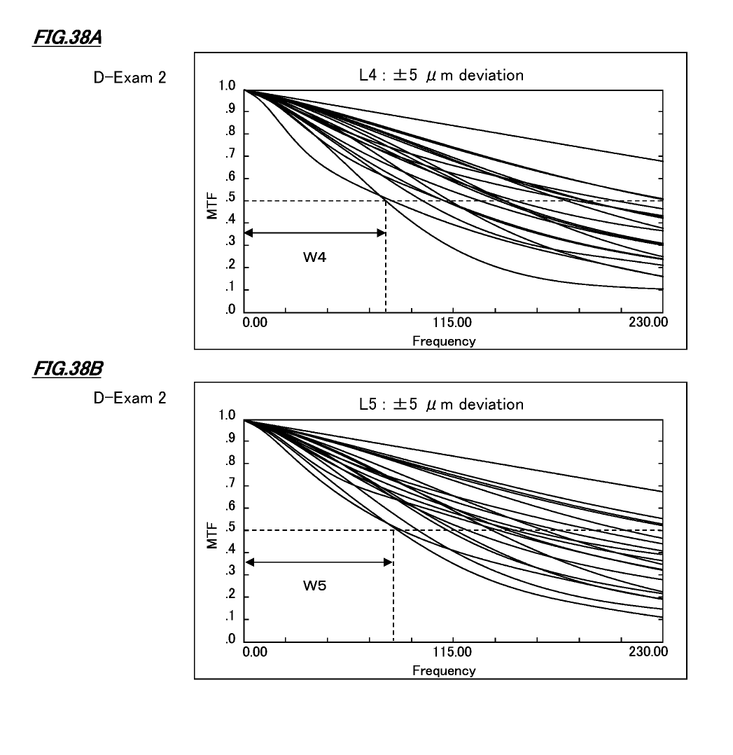

Next, referring to FIGS. 37A to 38B, in design example 2, in the case where optical axis misalignment occurs in the first lens element L1, MTF is deteriorated, and the frequency width W1 is narrow. However, the frequency width W1 in this case is wider than the frequency width W1 in comparative example. Accordingly, the requirements on manufacturing tolerances with respect to the first lens element L1 are low, as compared with the first lens element L1 in comparative example. Further, in design example 2, in the case where optical axis misalignment occurs in the second lens element L2, MTF is slightly deteriorated, and the frequency width W2 is slightly narrow. However, the frequency width W2 in this case is substantially the same as the frequency width W2 in comparative example.

Further, in design example 2, the degree of deterioration of MTF in the case where optical axis misalignment occurs in the fourth lens element L4 is considerably low, as compared with a case, in which optical axis misalignment occurs in the fourth lens element L4 in comparative example. The frequency width W4 in design example 2 is considerably wide, as compared with the frequency width W4 in comparative example. Accordingly, the requirements on manufacturing tolerances with respect to the fourth lens element L4 are considerably low, as compared with comparative example. Further, in design example 2, the degree of deterioration of MTF in the case where optical axis misalignment occurs in the fifth lens element L5 is considerably low, as compared with a case, in which optical axis misalignment occurs in the fifth lens element L5 in comparative example, and the frequency width W5 in design example 2 is considerably wide, as compared with the frequency width W5 in comparative example. Accordingly, the requirements on manufacturing tolerances with respect to the fifth lens element L5 are considerably low, as compared with comparative example.

In design example 2, the frequency width W3 with respect to the third lens element L3 is slightly narrow, as compared with the frequency width W3 in comparative example. However, in design example 2, the requirements on manufacturing tolerances with respect to the first lens element L1 are low, as compared with comparative example, and the requirements on manufacturing tolerances with respect to the fourth lens element L4 and the fifth lens element L5 are considerably low, as compared with comparative example. Accordingly, it can be concluded that the overall requirements on manufacturing tolerances are considerably low, as compared with comparative example.

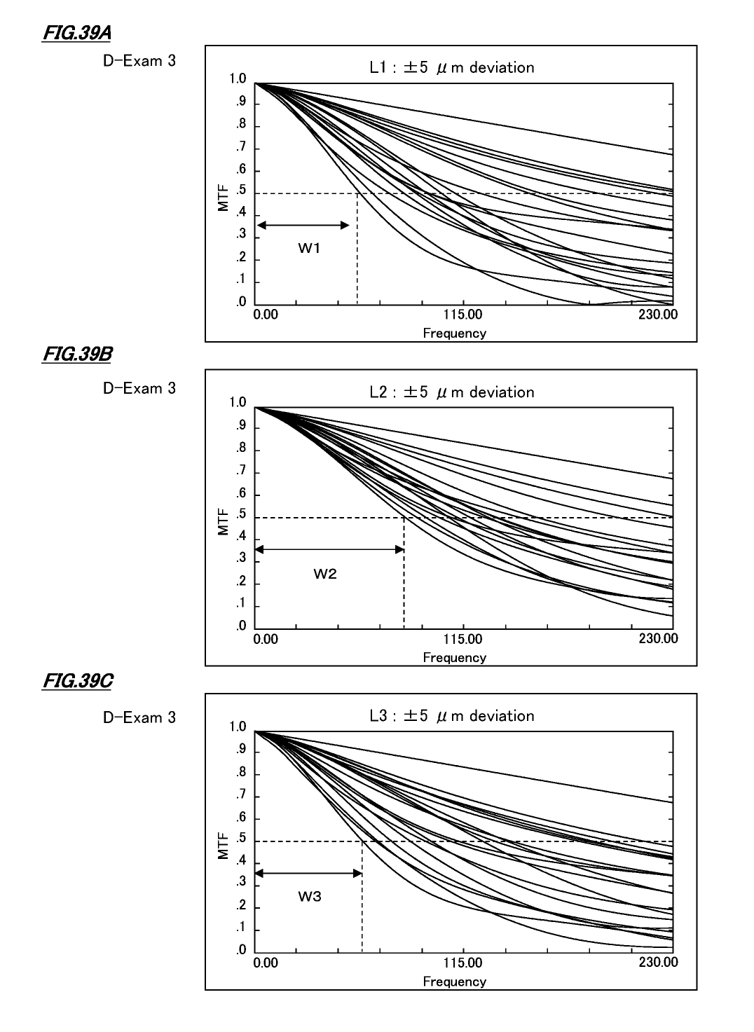

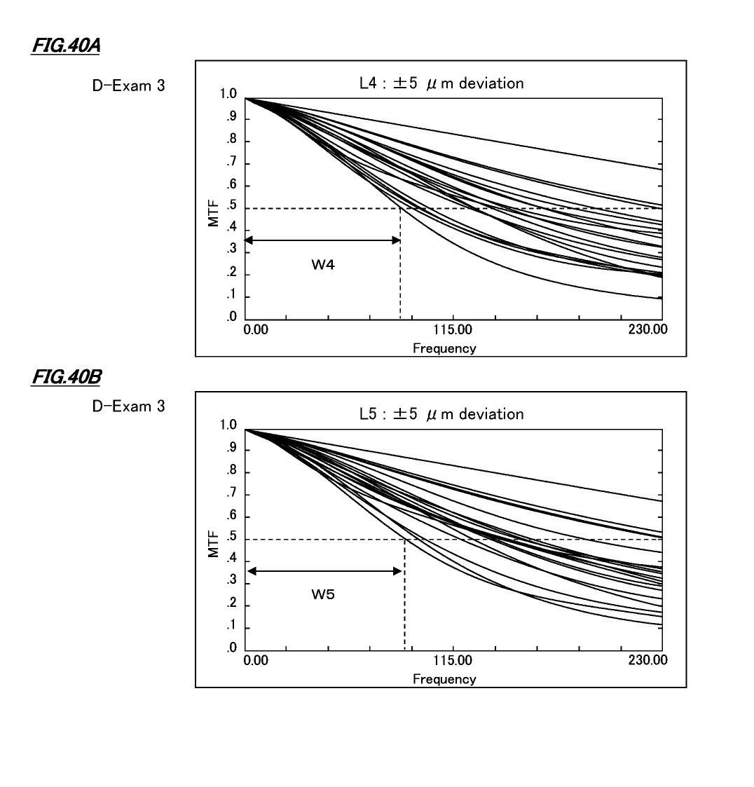

Next, referring to FIGS. 39A to 40B, in design example 3, the degree of deterioration of MTF is low, in all the cases, in which optical misalignment occurs in one of the first to fifth lens elements L1 to L5. In particular, the degree of deterioration of MTF in the case where optical axis misalignment occurs in the second lens element L2, the fourth lens element L4, and the fifth lens element L5 is considerably low, as compared with comparative example, and the frequency widths W2, W4, and W5 in design example 2 are considerably wide, as compared with the frequency widths W2, W4, and W5 in comparative example. Accordingly, the requirements on manufacturing tolerances with respect to the second lens element L2, the fourth lens element L4, and the fifth lens element L5 are considerably low, as compared with comparative example. As described above, in design example 3, the requirements on manufacturing tolerances with respect to each of the lens elements are low, and the overall requirements on manufacturing tolerances are also considerably low, as compared with comparative example.

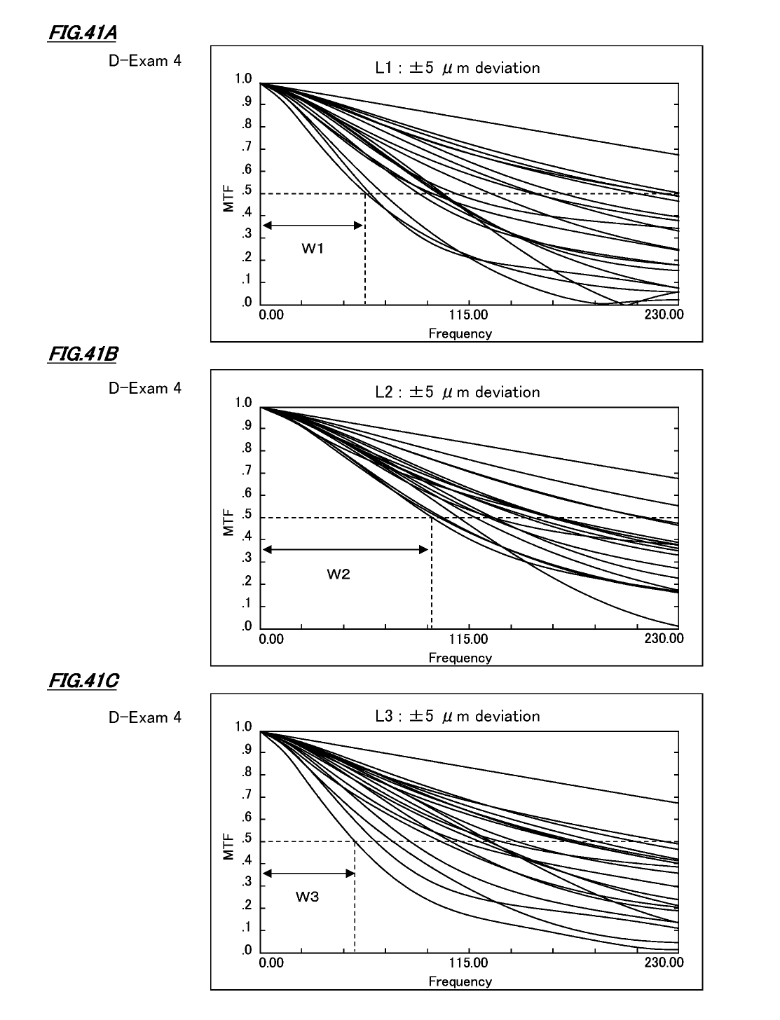

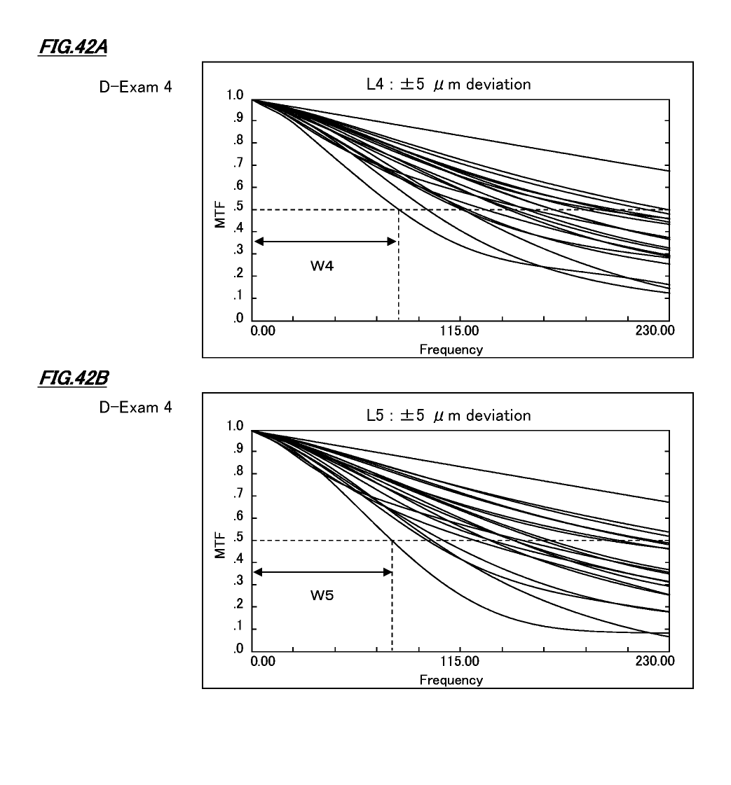

Next, referring to FIGS. 41A to 42B, in design example 4, although the frequency width W3 in the case where optical axis misalignment occurs in the third lens element L3 is slightly narrow, as compared with design example 3, the frequency width W3 in design example 4 is significantly wide as compared with the frequency widths W1 and W4 in comparative example, and still wider as compared with the frequency width W2 in comparative example. Accordingly, it can be concluded that, in design example 4, the requirements on manufacturing tolerances with respect to the third lens element L3 are low, as compared with comparative example.

Further, in design example 4, even in the case where optical axis misalignment occurs in the first lens element L1, deterioration of MTF is suppressed. In particular, the degree of deterioration of MTF in the case where optical axis misalignment occurs in the second lens element L2, the fourth lens element L4, and the fifth lens element L5 is considerably low, as compared with comparative example. Accordingly, the frequency widths W2, W4, and W5 in design example 4 are considerably wide, as compared with the frequency widths W2, W4, and W5 in comparative example. As a result, the requirements on manufacturing tolerances with respect to the second lens element L2, the fourth lens element L4 and the fifth lens element L5 are considerably low, as compared with comparative example. As described above, in design example 4, the requirements on manufacturing tolerances with respect to each of the lens elements are low, and the overall requirements on manufacturing tolerances are considerably low, as compared with comparative example.

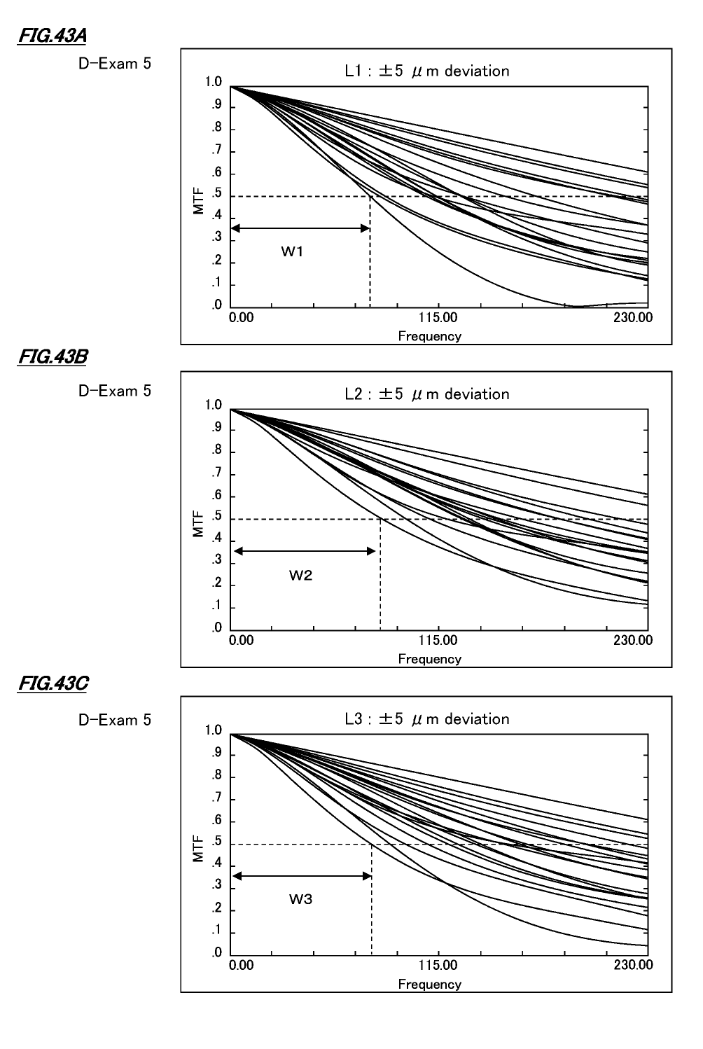

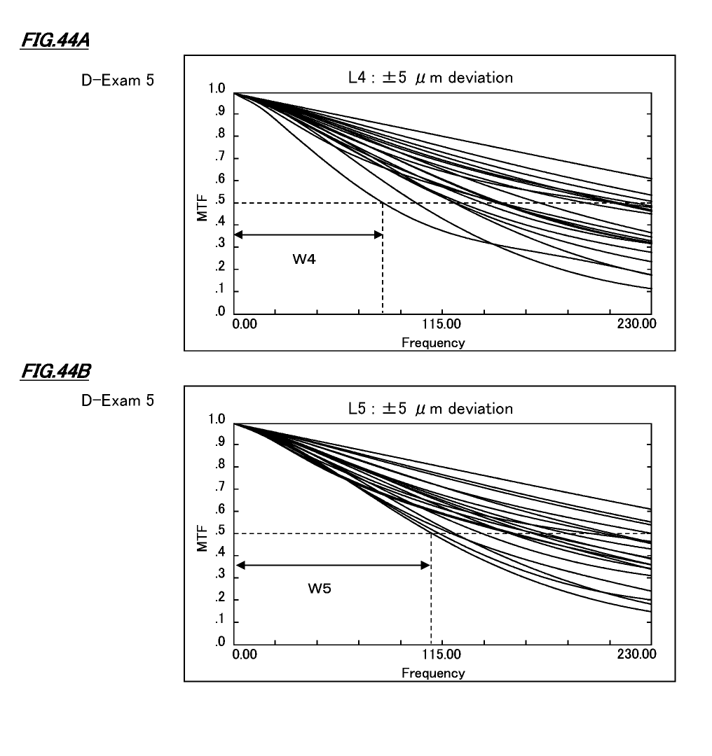

Next, referring to FIGS. 43A to 44B, in design example 5, deterioration of MTF is suppressed, in all the cases, in which optical misalignment occurs in one of the first to fifth lens elements L1 to L5. In design example 5, the degree of deterioration of MTF in the case where optical axis misalignment occurs in the first to fourth lens elements L1 to L4 is considerably low, and the frequency widths W1 to W4 are considerably wide. Further, the degree of deterioration of MTF in the case where optical axis misalignment occurs in the fifth lens element L5 is remarkably low, and the frequency width W5 is considerably wide. As described above, in design example 5, the requirements on manufacturing tolerances with respect to each of the lens elements are considerably low, and the overall requirements on manufacturing tolerances are remarkably low, as compared with comparative example.

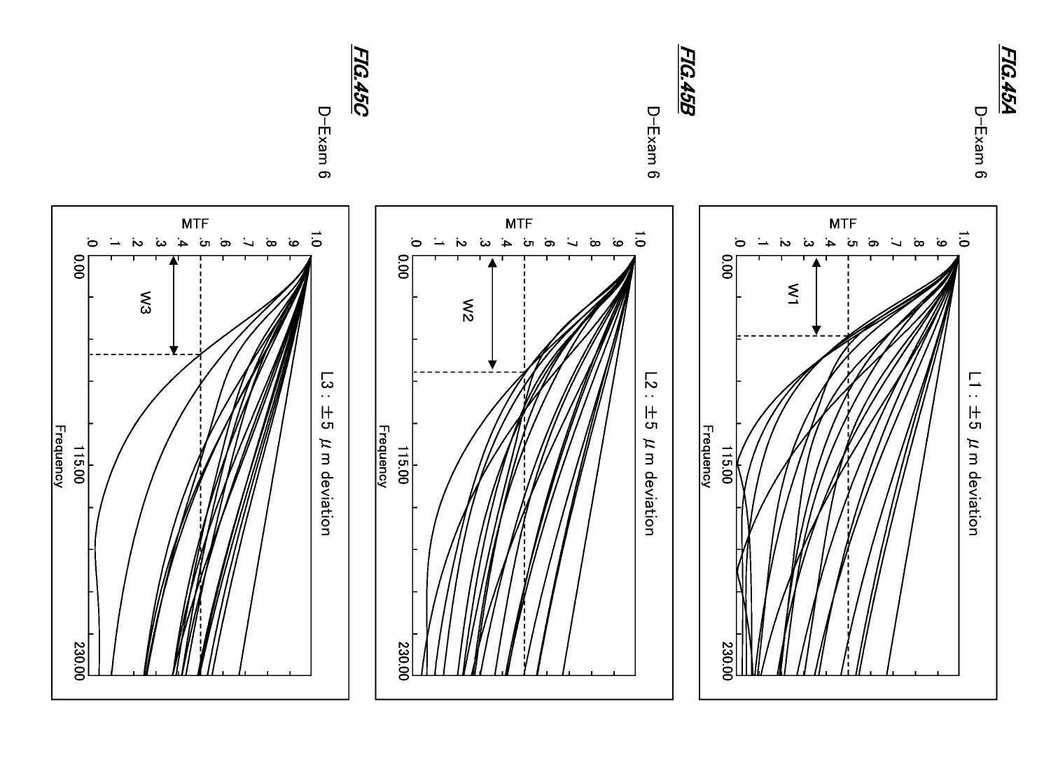

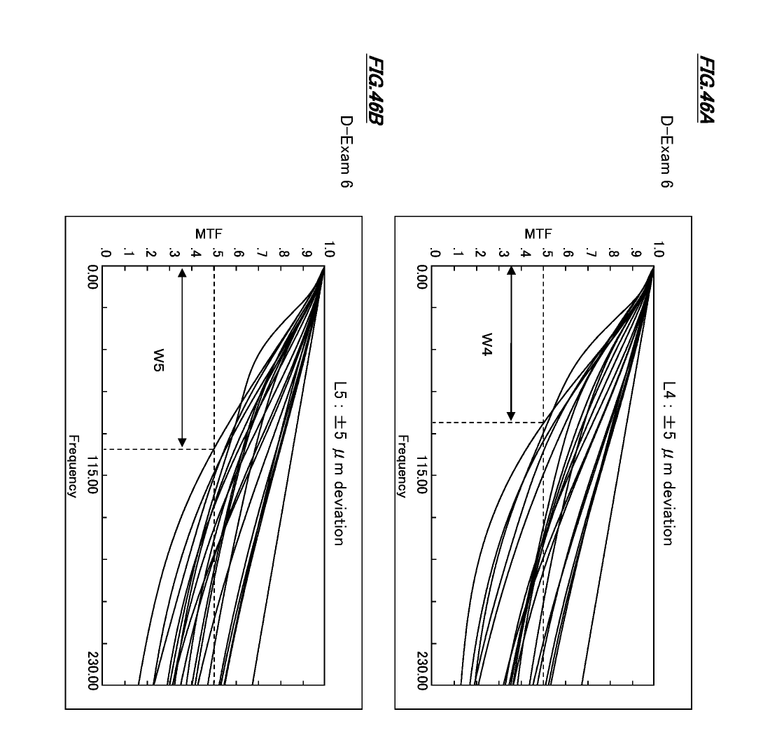

Next, referring to FIGS. 45A to 46B, in design example 6, the requirements on manufacturing tolerances with respect to the first lens element L1 are slightly high. However, the frequency width W1 in design example 6 are considerably wide, as compared with the frequency widths W1 and W4 in comparative example, and the requirements on manufacturing tolerances with respect to the first lens element L1 are low, as compared with comparative example. Further, in design example 6, the frequency width W2 and W3 with respect to the second lens element L2 and the third lens element L3 are wide. In particular, the frequency widths W4 and W5 with respect to the fourth lens element L4 and the fifth lens element L5 are considerably wide. Accordingly, in design example 6, the requirements on manufacturing tolerances with respect to the second lens element L2 and the third lens element L3 are low, and the requirements on manufacturing tolerances with respect to the fourth lens element L4 and the fifth lens element L5 are considerably low. As described above, in design example 6, the requirements on manufacturing tolerances with respect to each of the lens elements are considerably low, and the overall requirements on manufacturing tolerances are considerably low, as compared with comparative example.

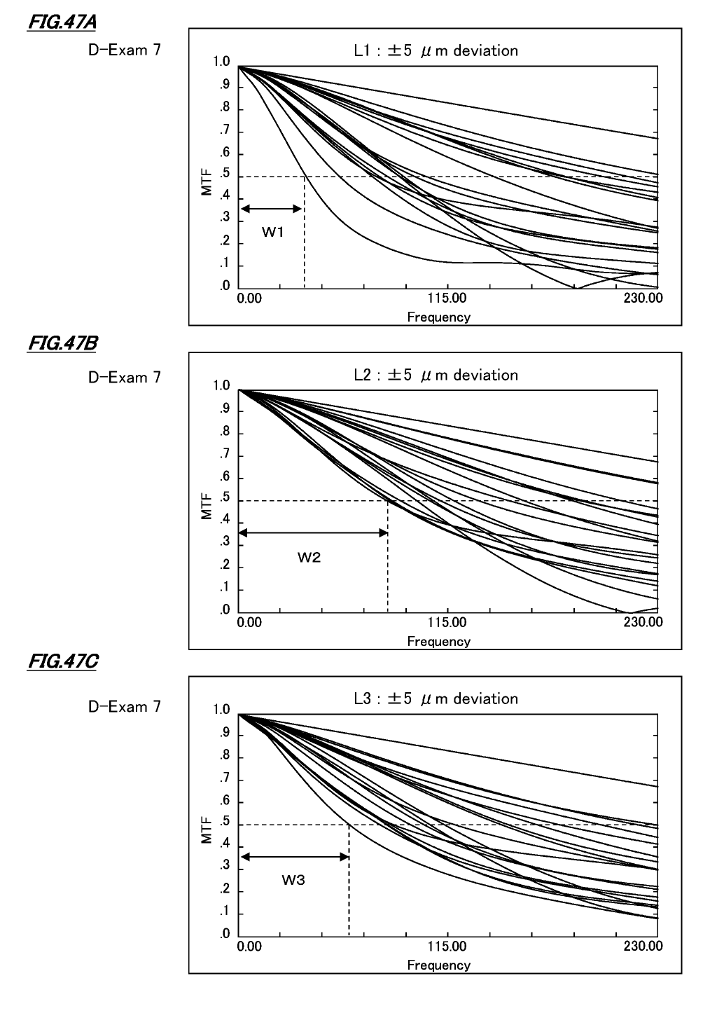

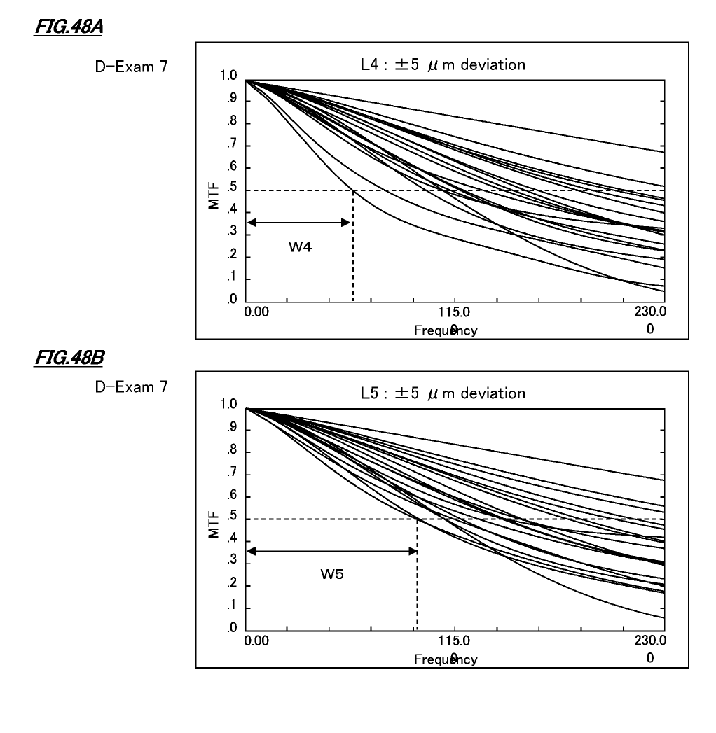

Next, referring to FIGS. 47A to 48B, in design example 7, the requirements on manufacturing tolerances with respect to the first lens element L1 are slightly high. However, the frequency width W1 in deign example 7 is wider than the frequency width W1 in comparative example, and the requirements on manufacturing tolerances with respect to the first lens element L1 are low, as compared with comparative example. Further, in design example 7, the frequency widths W3 and W4 with respect to the third lens element L3 and the fourth lens element L4 are wide. In particular, the frequency widths W2 and W5 with respect to the second lens element L2 and the fifth lens element L5 are considerably wide. Accordingly, in design example 7, the requirements on manufacturing tolerances with respect to the third lens element L3 and the fourth lens element L4 are low, and the requirements on manufacturing tolerances with respect to the second lens element L2 and the fifth lens element L5 are considerably low. As described above, in design example 7, the requirements on manufacturing tolerances with respect to each of the lens elements are considerably low, and the overall requirements on manufacturing tolerances are considerably low, as compared with comparative example.

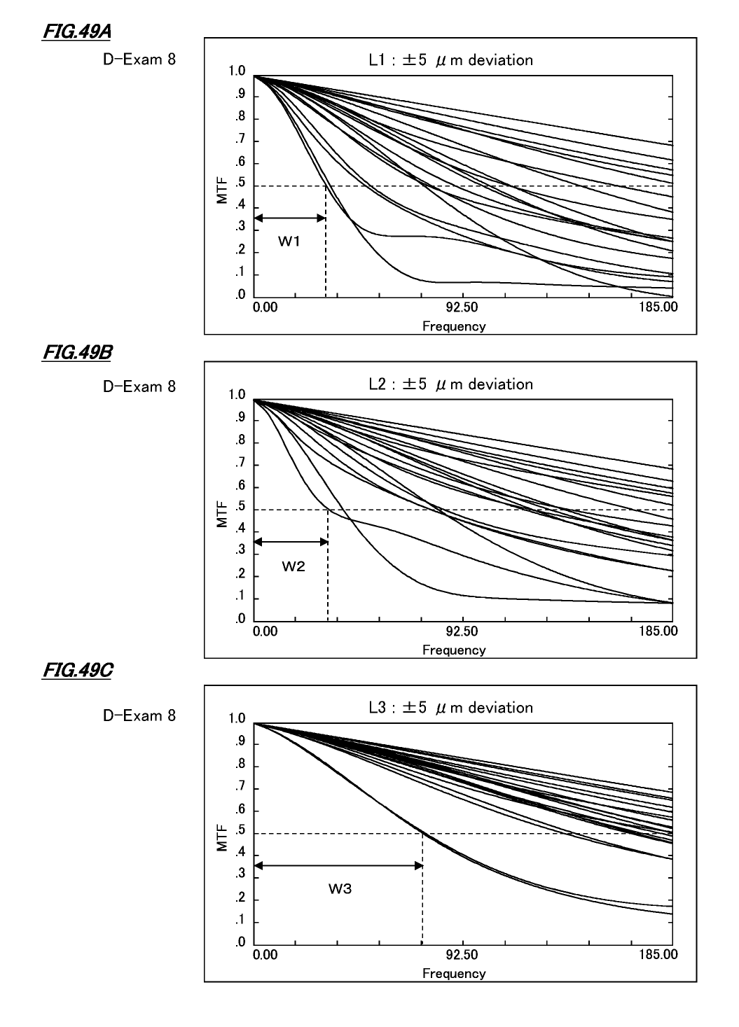

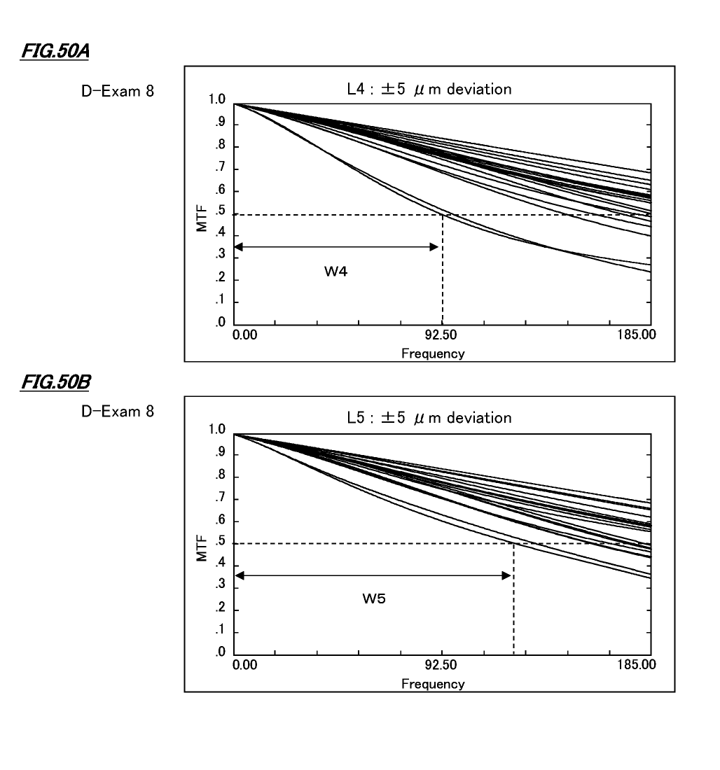

Next, referring to FIGS. 49A to 50B, in design example 8, the requirements on manufacturing tolerances with respect to the first lens element L1 and the second lens element L2 are slightly high. However, the frequency widths W1 and W2 in deign example 8 are wider than the frequency width W1 in comparative example, and the requirements on manufacturing tolerances with respect to the first lens element L1 and the second lens element L2 are low, as compared with comparative example. Further, in design example 8, the frequency widths W3 and W4 with respect to the third lens element L3 and the fourth lens element L4 are considerably wide. In particular, the frequency width W5 with respect to the fifth lens element L5 is remarkably wide. Accordingly, in design example 8, the requirements on manufacturing tolerances with respect to the third lens element L3 and the fourth lens element L4 are considerably low, and the requirements on manufacturing tolerances with respect to the fifth lens element L5 are remarkably low. As described above, in design example 8, the requirements on manufacturing tolerances with respect to each of the lens elements are considerably low, and the overall requirements on manufacturing tolerances are remarkably low, as compared with comparative example.

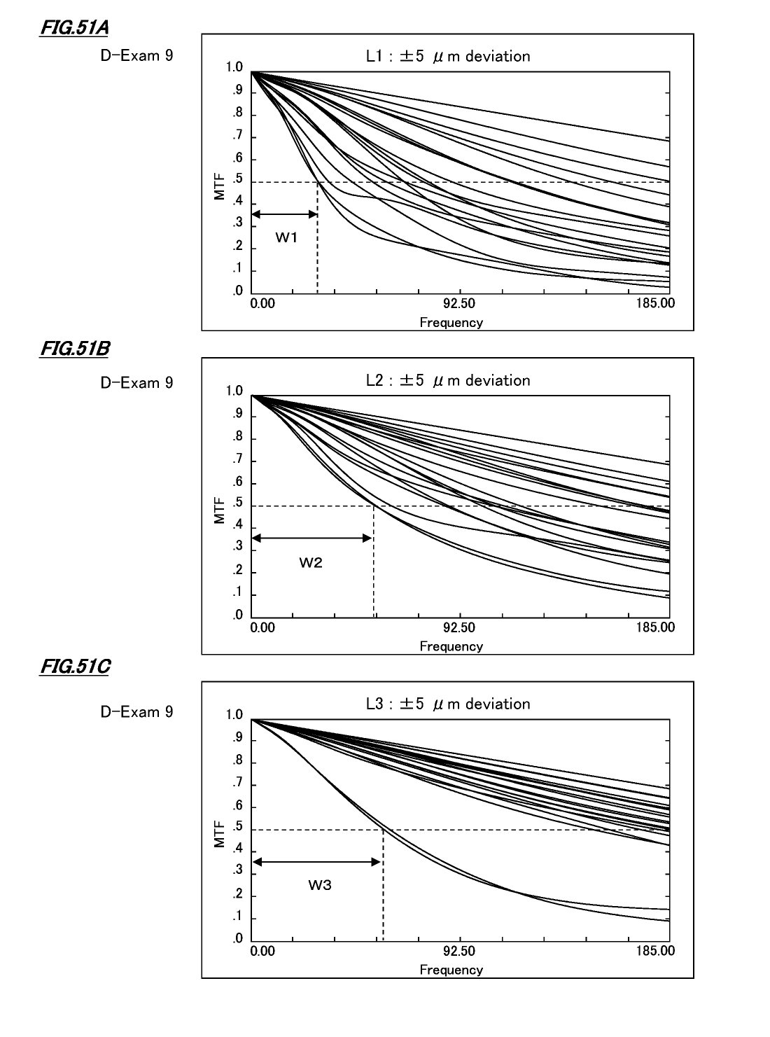

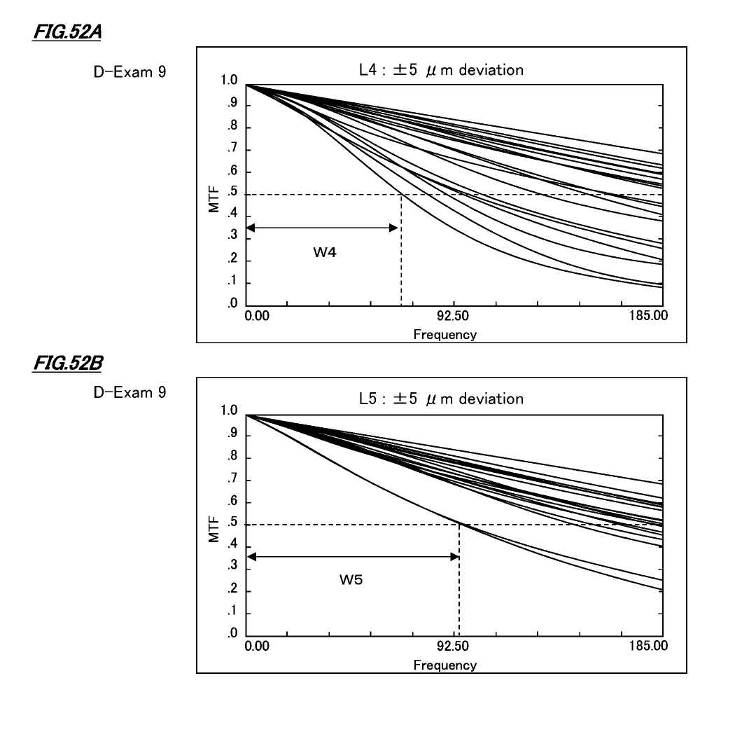

Next, referring to FIGS. 51A to 52B, in design example 9, the requirements on manufacturing tolerances with respect to the first lens element L1 and the second lens element L2 are slightly high. However, the frequency widths W1 and W2 in deign example 9 are wider than the frequency width W1 in comparative example, and the requirements on manufacturing tolerances with respect to the first lens element L1 and the second lens element L2 are low, as compared with comparative example. Further, in design example 9, the frequency widths W3 and W4 with respect to the third lens element L3 and the fourth lens element L4 are considerably wide. In particular, the frequency width W5 with respect to the fifth lens element L5 is remarkably wide. Accordingly, in design example 9, the requirements on manufacturing tolerances with respect to the third lens element L3 and the fourth lens element L4 are considerably low, and the requirements on manufacturing tolerances with respect to the fifth lens element L5 are remarkably low. As described above, in design example 9, the requirements on manufacturing tolerances with respect to each of the lens elements are considerably low, and the overall requirements on manufacturing tolerances are remarkably low, as compared with comparative example.

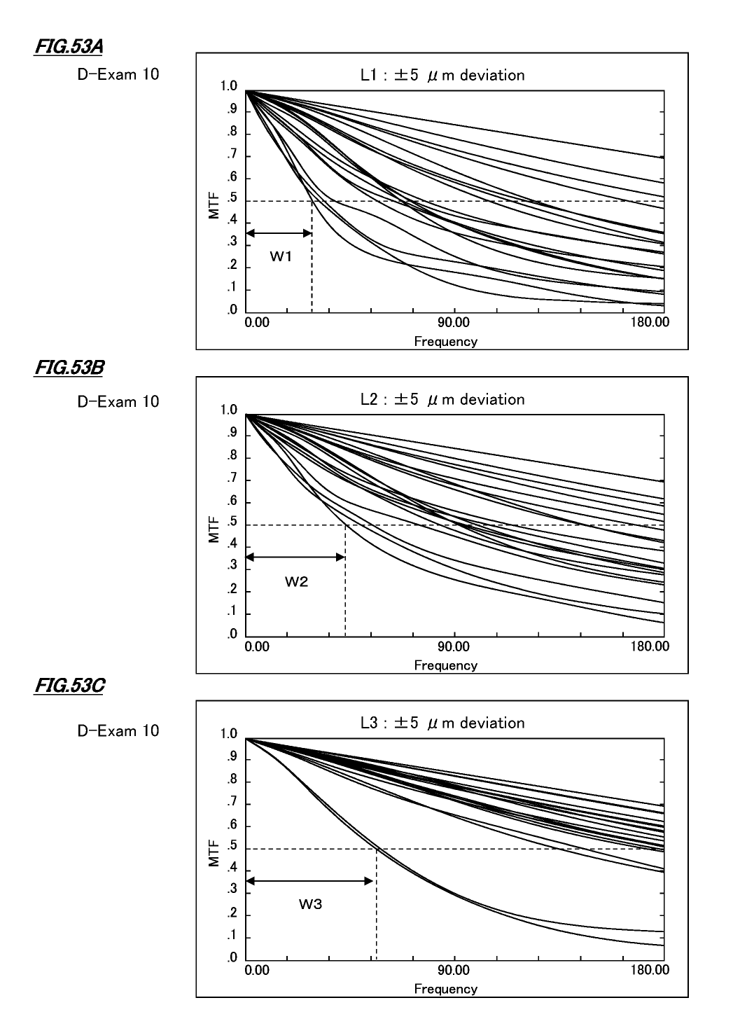

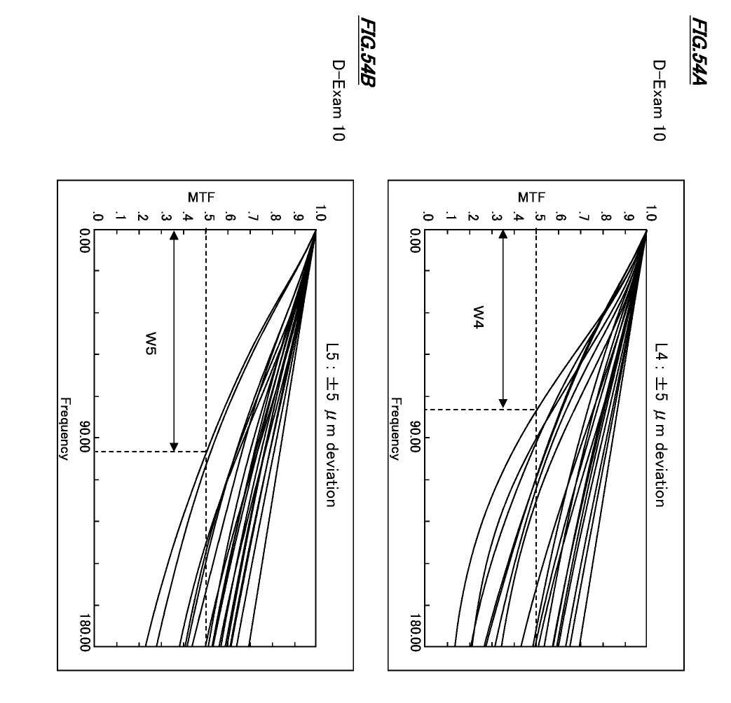

Next, referring to FIGS. 53A to 54B, in design example 10, the requirements on manufacturing tolerances with respect to the first lens element L1 and the second lens element L2 are slightly high. However, the frequency widths W1 and W2 in deign example 10 are wider than the frequency width W1 in comparative example, and the requirements on manufacturing tolerances with respect to the first lens element L1 and the second lens element L2 are low, as compared with comparative example. Further, in design example 10, the frequency widths W3 and W4 with respect to the third lens element L3 and the fourth lens element L4 are considerably wide. In particular, the frequency width W5 with respect to the fifth lens element L5 is remarkably wide. Accordingly, in design example 10, the requirements on manufacturing tolerances with respect to the third lens element L3 and the fourth lens element L4 are considerably low, and the requirements on manufacturing tolerances with respect to the fifth lens element L5 are remarkably low. As described above, in design example 10, the requirements on manufacturing tolerances with respect to each of the lens elements are considerably low, and the overall requirements on manufacturing tolerances are remarkably low, as compared with comparative example.

As described above, in design examples 1 to 10, the requirements on manufacturing tolerances with respect to each of the lens elements are low, as compared with comparative example, and the overall requirements on manufacturing tolerances are low, as compared with comparative example. Therefore, according to the configuration of design examples, it is possible to design an imaging lens with less deterioration of imaging characteristics, as compared with comparative example.

In particular, in design examples 3, 4, 5, and 7, in which an aperture stop is disposed between the second lens element L2 and the third lens element L3, deterioration of MTF with respect to optical axis misalignment of each of the lens elements is effectively suppressed, and the overall requirements on manufacturing tolerances are considerably low. Accordingly, it can be concluded that disposing an aperture stop between the second lens element L2 and the third lens element L3 is advantageous in alleviating the requirements on manufacturing tolerances, and in designing the imaging lens 10 with less deterioration of imaging characteristics. The above advantages can also be obtained, in the case where the first lens element L1 and the third lens element L3 are not a meniscus lens element but a convex lens element.

### Configuration of Prior Art Examples

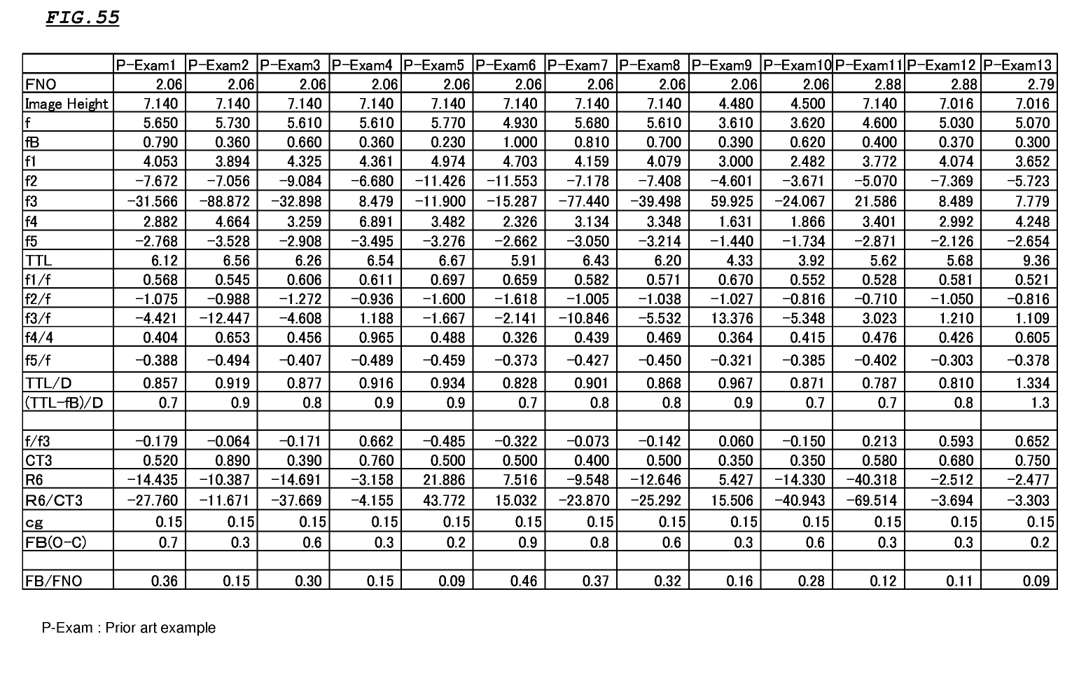

Comparative example as described above is an example of an imaging lens uniquely designed by the inventor of the present application, based on the configuration disclosed in Japanese Patent No. 4,947,237. In this section, the parameter values of the imaging lens disclosed in Japanese Patent No. 4,947,237 are described referring to FIG. 55 in comparison with design examples 1 to 8.

Referring to FIG. 55, prior art examples 1 to 13 respectively correspond to examples 1 to 13 disclosed in Japanese Patent No. 4,947,237. Examples 1 to 13 disclosed in Japanese Patent No. 4,947,237 are configured such that all the fourth lens elements are constituted of a lens element having a positive refractive power. In this point, the configuration disclosed in Japanese Patent No. 4,947,237 is different from the configuration of the invention.

Comparing between the conditional expressions (6) to (9), and prior art examples 1 to 13 disclosed in Japanese Patent No. 4,947,237 shown in FIG. 55, prior art examples 1 to 10 satisfy the conditional expression (6), but prior art examples 11 to 13 do not satisfy the conditional expression (6). Specifically, in prior art examples 11 to 13, intended fastness as achieved by the inventive design examples is not secured. Further, none of prior art examples 1 to 13 satisfies the conditional expression (7), and the height of the imaging lens in prior art examples 1 to 13 is large. Further, prior art examples other than prior art example 6 do not satisfy the conditional expression (8). Specifically, in prior art examples other than prior art example 6, the flange back length is not a length taking into consideration of dust, and the design configuration of prior art examples other than prior art example 6 makes it difficult to avoid influence of dust on a captured image. Further, none of prior art example 1 to 13 satisfies the conditional expression (9). As a result, the design configuration of prior art examples makes it difficult to avoid the drawbacks such as collision between the fifth lens element L5 and the cover glass cg, and obstruction involved in providing the wire bonding wb.

### 3. Configuration Example of Imaging Device

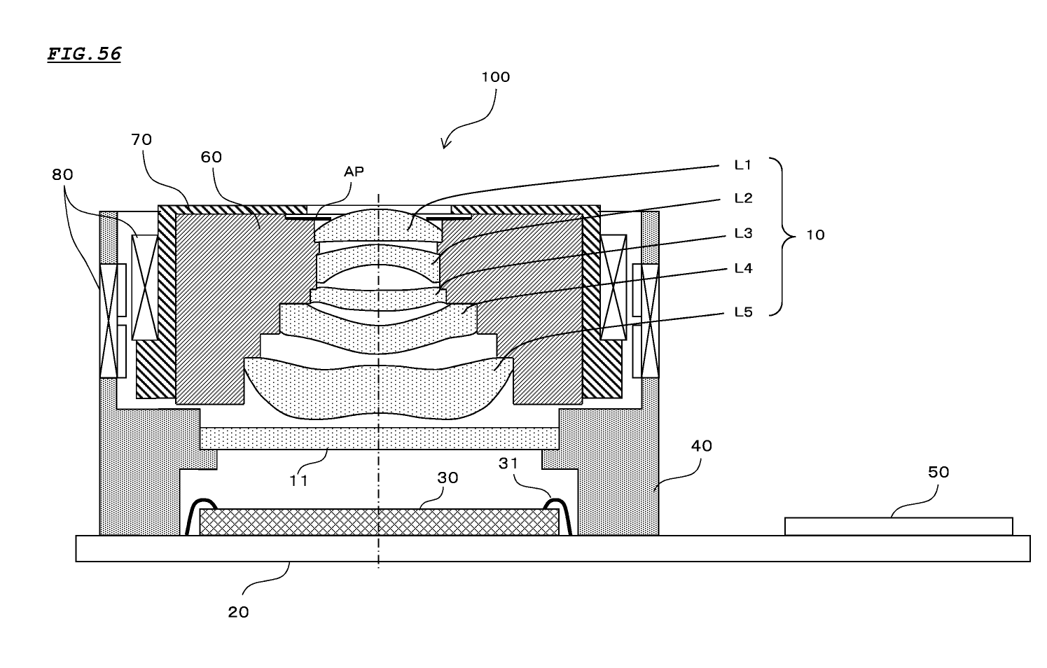

FIG. 56 is a diagram showing a configuration example of an imaging device 100 loaded with the imaging lens 10 having the aforementioned configuration. In FIG. 56, a portion corresponding to a lens module is indicated as a section cut by a plane including an optical axis. In the configuration example shown in FIG. 56, the aperture stop AP is disposed on the object side of the first lens element L1. Alternatively, as shown in FIGS. 3B and 3C, the aperture stop AP may be disposed between the first lens element L1 and the second lens element L2, or between the second lens element L2 and the third lens element L3.

In the configuration example shown in FIG. 56, an image sensor 30, a base member 40, and a DSP 50 are mounted on a circuit board 20. The image sensor 30 is electrically connected to the circuit board 20 by a wire bonding 31. A cover glass 11 for covering the image sensor 30 is mounted on the base member 40.

The imaging lens 10 is held on a lens barrel 60. The lens barrel 60 is formed with annular step portions for receiving the first to fifth lens elements L1 to L5. The first to fifth lens elements L1 to L5 are received in the annular step portions, and are held in the lens barrel 60. The aperture stop AP is mounted on a step portion formed in the object-side surface of the lens barrel 60.

The first to fifth lens elements L1 to L5 are respectively made of the glass materials having the characteristics shown in Table 1 as described above. The first to fifth lens elements L1 to L5 may be formed by injection molding with use of a resin material.

The lens barrel 60 has a screw groove in the outer periphery thereof. The lens barrel 60 is fastened and held in a lens holder 70 having a screw groove in the inner surface thereof. The lens holder 70 is supported on the base member 40 to be movable along the optical axis of the imaging lens 10 by a predetermined actuator 80. The actuator 80 may be constituted of a well-known zoom actuator or focus actuator, for instance.

The imaging lens 10 forms light incident from the object side on the image sensor 30. The image sensor 30 outputs an image signal to the DSP 50 via the wire bonding 31. The DSP 50 is communicatively connected to a microcomputer built in the main body of a mobile phone or a like device. The DSP 50 processes the image signal received from the image sensor 30, and outputs the processed signal to the microcomputer on the main body side.

### Advantages of Embodiment

As described above, according to the embodiment, it is possible to implement the fast imaging lens 10 with a small F-number, and to suppress an increase in the entire length of the imaging lens 10 in the optical axis direction. In addition, according to the embodiment, it is possible to alleviate the requirements on manufacturing tolerances with respect to each of the lens elements, and to design the imaging lens 10 with less deterioration of imaging characteristics.

Further, constituting the first lens element L1 of a meniscus lens element is advantageous in securing an edge thickness on the periphery of the first lens element L1, regardless of an increase in the lens diameter of the first lens element L1, in order to implement the fast imaging lens 10 with a small F-number.

Further, disposing the aperture stop AP on the object side of the first lens element L1 is further advantageous in securing an edge thickness on the periphery of the first lens element L1, and in suppressing an increase in the incident angle of light ray with respect to the image plane.

Further, disposing the aperture stop AP between the first lens element L1 and the second lens element L2 is advantageous in suppressing an increase in the incident angle of light ray with respect to the image plane, while alleviating the requirements on manufacturing tolerances.

Further, disposing the aperture stop AP between the second lens element L2 and the third lens element L3 is advantageous in alleviating the requirements on manufacturing tolerances.

Further, designing the imaging lens 10 to satisfy the conditional expressions (6) and (7) is advantageous in implementing the fast imaging lens 10 while suppressing an increase in the entire length of the imaging lens in the optical axis direction.

Further, designing the imaging lens 10 to satisfy the conditional expression (8) is advantageous in implementing the imaging lens 10 capable of avoiding an influence of dust on a captured image.

Further, setting a positive refractive power of the third lens element L3 to satisfy the conditional expression (1) is advantageous in implementing the fast and low-height imaging lens 10.

Further, constituting the third lens element L3 of a meniscus lens element is advantageous in securing an edge thickness of the third lens element L3, and in bringing the third lens element L3 and the fourth lens element L4 in proximity to each other. This makes it possible to effectively reduce the entire length of the imaging lens 10 in the optical axis direction.

Further, designing the third lens element L3 to satisfy the conditional expression (2) is advantageous in securing a long flange back length, and in properly correcting field curvature and astigmatism.

Further, designing the imaging lens 10 to satisfy the conditional expression (9) is advantageous in smoothly disposing the components to be disposed between the imaging lens and the image plane (image sensor).

Further, disposing the aperture stop AP on the object side than the image-side lens surface of the third lens element L3 is advantageous in implement the fast imaging lens while suppressing an increase in the entire length of the imaging lens in the optical axis direction, and alleviating the requirements on manufacturing tolerances.

Further, configuring the object-side surface and the image-side surface of the third lens element L3 to have such a shape that the curvature thereof decreases, as approaching from the center of the third lens element L3 toward the periphery thereof is advantageous in suppressing field curvature and aberrations generated in light transmitting through the peripheral portion of the third lens element L3.

Further, constituting the fifth lens element L5 of a lens element having a positive refractive power is advantageous in shortening the flange back length in the case where the flange back length tends to increase.

Further, constituting the fifth lens element L5 of a lens element having a negative refractive power is advantageous in designing the imaging lens capable of easily correcting aberrations generated on the image plane.

Further, setting the F-number of the imaging lens 10 to 2.4 or less, and providing a configuration (so-called field stop) for cutting light rays in a predetermined range from the outer peripheral edge of the imaging lens 10 toward the inner periphery thereof, out of the light rays impinging on the imaging lens 10, is advantageous in suppressing aberrations generated in light transmitting through the peripheral portion of the imaging lens.

The embodiment and design examples of the invention have been described as above. The invention, however, is not limited to the foregoing embodiment and design examples, and the embodiment of the invention may be changed or modified in various ways other than the above.

For instance, the design values of the first to fifth lens elements L1 to L5 are not limited to the values shown in FIGS. 7 to 9. Further, the parameter values of the first to fifth lens elements L1 to L5 are not limited to the values shown in FIG. 5.

Further, the configuration of the imaging device 100 is not limited to the configuration example shown in FIG. 56, but a configuration other than the above may be employed, as necessary.

The embodiment of the invention may be changed or modified in various ways as necessary, as far as such changes and modifications do not depart from the scope of the claims of the invention hereinafter defined.

What is claimed is:

1. An imaging lens for forming an image of a subject on a light receiving surface of an imaging sensor element, comprising, in order from an object side to an image side:
a first lens element having a positive refractive power and having a convex surface toward the object side;
a second lens element of a meniscus shape having a negative refractive power and having a concave surface toward the image side;
a third lens element having a positive refractive power and having a convex surface toward the image side;
a fourth lens element of a meniscus shape having a negative refractive power and having a convex surface toward the image side; and
a fifth lens element of a meniscus shape having a concave surface toward the image side.

2. The imaging lens according to claim 1, wherein
the first lens element is a lens element of a meniscus shape.

3. The imaging lens according to claim 1, further comprising:
an aperture stop disposed on the object side of the first lens element.

4. The imaging lens according to claim 1, further comprising:
an aperture stop disposed between the second lens element and the third lens element.

5. The imaging lens according to claim 1, wherein
the imaging lens satisfies the following conditional expressions:
FNO<2.6
(TTL−fB)/D≦0.6
where parameters in the expressions are respectively defined as follows:
FNO: an F-number of the imaging lens,
TTL: an axial distance between an image plane and an object-side surface of the lens element closest to the object side,
D: a length of a diagonal line of an image size, and
fB: a flange back length.

6. The imaging lens according to claim 1, wherein
the imaging lens satisfies the following conditional expression:
FB/FNO≧0.4
where a parameter in the expression is defined as follows:
FB: a value of fB after optical conversion.

7. The imaging lens according to claim 1, wherein
the imaging lens satisfies the following conditional expression:
f3/f≧1.4
where parameters in the expression are respectively defined as follows:
f3: a focal length of the third lens element, and
f: a focal length of the imaging lens.

8. The imaging lens according to claim 1, wherein
the third lens element is a lens element of a meniscus shape.

9. The imaging lens according to claim 1, wherein
the imaging lens satisfies the following conditional expression:
R6/CT3<−5
where parameters in the expression are respectively defined as follows:
R6: a curvature radius of an image-side surface of the third lens element, and
CT3: a center thickness of the third lens element.

10. An imaging device, comprising:
an imaging lens; and
an imaging sensor element which receives light collected on the imaging lens,
the imaging lens including in order from an object side to an image side:
a first lens element having a positive refractive power and having a convex surface toward the object side;
a second lens element of a meniscus shape having a negative refractive power and having a concave surface toward the image side;
a third lens element having a positive refractive power and having a convex surface toward the image side;
a fourth lens element of a meniscus shape having a negative refractive power and having a convex surface toward the image side; and
a fifth lens element of a meniscus shape having a concave surface toward the image side.

11. The imaging device according to claim 10, wherein
the first lens element is a lens element of a meniscus shape.

12. The imaging device according to claim 10, further comprising:
an aperture stop disposed on the object side of the first lens element.

13. The imaging device according to claim 10, further comprising:
an aperture stop disposed between the second lens element and the third lens element.

14. The imaging device according to claim 10, wherein
the imaging lens satisfies the following conditional expressions:
FNO<2.6
(TTL−fB)/D≦0.6
where parameters in the expressions are respectively defined as follows:
FNO: an F-number of the imaging lens,
TTL: an axial distance between an image plane and an object-side surface of the lens element closest to the object side,
D: a length of a diagonal line of an image size, and
fB: a flange back length.

15. The imaging device according to claim 10, wherein
the imaging lens satisfies the following conditional expression:
FB/FNO≧0.4
where a parameter in the expression is defined as follows:
FB: a value of fB after optical conversion.

16. The imaging device according to claim 10, wherein
the imaging lens satisfies the following conditional expression:
f3/f≧1.4
where parameters in the expression are respectively defined as follows:
f3: a focal length of the third lens element, and
f: a focal length of the imaging lens.

17. The imaging device according to claim 10, wherein
the third lens element is a lens element of a meniscus shape.

18. The imaging device according to claim 10, wherein
the imaging lens satisfies the following conditional expression:
R6/CT3<−5
where parameters in the expression are respectively defined as follows:
R6: a curvature radius of an image-side surface of the third lens element, and
CT3: a center thickness of the third lens element.
